(19) United States
(12) Patent Application Publication
(10) Pub. No.: US 2026/0119978 A1
(43) Pub. Date: Apr. 30, 2026

(54) Dynamically Switching Parameter-Efficient Fine-Tuning Profiles During Machine-Learned Model Execution

(71) Applicant: DeepMind Technologies Limited, London (GB)

(72) Inventors: Florian Nils Hartmann, Zurich (CH); Matthew Sharifi, Kilchberg (CH)

(21) Appl. No.: 18/933,714

(22) Filed: Oct. 31, 2024

(51) Int. Cl. G06N 20/00

(52) U.S. Cl. CPC G06N 20/00

(57) ABSTRACT

An example method includes inputting, to a machine-learned model instantiated with a first parameter profile, a first input; generating, by a computing system executing the machine-learned model instantiated with the first parameter profile, and based on the first input, one or more first outputs; mapping one or more profile identifier elements of the one or more first outputs to a second parameter profile; inputting, to the machine-learned model instantiated with the second parameter profile, a second input; generating, by the computing system executing the machine-learned model instantiated with the second parameter profile, and based on the second input, one or more second outputs; and generating a response based on the one or more first outputs and the one or more second outputs.

### BACKGROUND

A computer can receive inputs. The computer can execute instructions to process the inputs to generate outputs using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In an aspect, the present disclosure provides a first example computer-implemented method. In some implementations, the first example computer-implemented method includes inputting, to a machine-learned model instantiated with a first parameter profile that defines one or more first learned parameter values for the machine-learned model, a first input. In some implementations, the first example computer-implemented method includes generating, by a computing system executing the machine-learned model instantiated with the first parameter profile, and based on the first input, one or more first outputs. In some implementations, the first example computer-implemented method includes mapping one or more profile identifier elements of the one or more first outputs to a second parameter profile, wherein the second parameter profile defines one or more second learned parameter values for the machine-learned model. In some implementations, the first example computer-implemented method includes inputting, to the machine-learned model instantiated with the second parameter profile, a second input, wherein the second input is based on at least one of the first input or the one or more first outputs. In some implementations, the first example computer-implemented method includes generating, by the computing system executing the machine-learned model instantiated with the second parameter profile, and based on the second input, one or more second outputs. In some implementations, the first example computer-implemented method includes generating a response based on the one or more first outputs and the one or more second outputs.

In some implementations, the first example computer-implemented method includes loading, into a memory of the computing system, a first plurality of values respectively for a plurality of learned parameters of the machine-learned model, the first plurality of values defined according to the first parameter profile. In some implementations, the first example computer-implemented method includes generating the one or more first outputs using the first plurality of values. In some implementations, the first example computer-implemented method includes loading, into the memory, a second plurality of values respectively for the plurality of learned parameters, the second plurality of values defined according to the second parameter profile. In some implementations, the first example computer-implemented method includes generating the one or more second outputs using the second plurality of values.

In some implementations of the first example computer-implemented method, the second parameter profile defines delta values. In some implementations of the first example computer-implemented method, the second plurality of values are obtained by combining the delta values with corresponding baseline values for the plurality of learned parameters.

In some implementations of the first example computer-implemented method, the second parameter profile defines replacement values. In some implementations of the first example computer-implemented method, the second plurality of values are obtained by using the replacement values in lieu of corresponding baseline values for the plurality of learned parameters.

In some implementations of the first example computer-implemented method, the first plurality of values are the baseline values.

In some implementations of the first example computer-implemented method, the loading, into the memory, of the second plurality of values is performed responsive to the mapping of the one or more profile identifier elements to the second parameter profile.

In some implementations of the first example computer-implemented method, the second input includes the first input.

In some implementations of the first example computer-implemented method, the second input includes the one or more first outputs.

In some implementations, the first example computer-implemented method includes generating one or more first-profile activations based on the first input using the first parameter profile. In some implementations, the first example computer-implemented method includes generating the one or more first outputs based on the first-profile activations based on the first input. In some implementations, the first example computer-implemented method includes generating one or more second-profile activations based on the first input using the second parameter profile. In some implementations, the first example computer-implemented method includes generating the one or more second outputs based on the second-profile activations based on the first input.

In some implementations of the first example computer-implemented method, the one or more first-profile activations based on the first input includes attention values computed between elements of the first input using the one or more first learned parameter values. In some implementations of the first example computer-implemented method, the one or more second-profile activations based on the first input includes attention values computed between the elements in the first input using the one or more second learned parameter values.

In some implementations, the first example computer-implemented method includes caching the one or more first-profile activations based on the first input. In some implementations, the first example computer-implemented method includes mapping, to the first parameter profile, one or more second profile identifier elements generated by the machine-learned model based on a third input that includes the first input. In some implementations, the first example computer-implemented method includes generating one or more first-profile activations based on the third input using the one or more first learned parameter values, wherein generating the one or more first-profile activations based on the third input includes, for a portion of the third input corresponding to the first input, retrieving the cached one or more first-profile activations based on the first input. In some implementations, the first example computer-implemented method includes generating, by the computing system executing the machine-learned model instantiated with the first parameter profile, and based on the one or more first-profile activations based on the third input, one or more third outputs.

In some implementations of the first example computer-implemented method, the third input is the second input. In some implementations of the first example computer-implemented method, the one or more second outputs include the one or more second profile identifier elements.

In some implementations of the first example computer-implemented method, generating the one or more first outputs includes generating a swap profile element that signals a profile swap. In some implementations of the first example computer-implemented method, generating the one or more first outputs includes generating the one or more profile identifier elements.

In some implementations of the first example computer-implemented method, the swap profile element is a token sampled from an output vocabulary of tokens of the machine-learned model based on a prediction value associated with the swap profile element, the prediction value conditioned on one or more preceding tokens in a context window of the machine-learned model.

In some implementations, the first example computer-implemented method includes training the one or more first parameter values using a first training dataset. In some implementations of the first example computer-implemented method, training the one or more first parameter values includes, for a respective batch of one or more first training examples in the first training dataset, inputting, to the machine-learned model, at least a portion of the respective batch of one or more first training examples. In some implementations of the first example computer-implemented method, training the one or more first parameter values includes, for a respective batch of one or more first training examples in the first training dataset, generating, by the machine-learned model instantiated with the first parameter profile, one or more respective first outputs. In some implementations of the first example computer-implemented method, training the one or more first parameter values includes, for a respective batch of one or more first training examples in the first training dataset, computing a first respective loss based on the one or more respective first outputs. In some implementations of the first example computer-implemented method, training the one or more first parameter values includes, for a respective batch of one or more first training examples in the first training dataset, generating, based on the first respective loss, a first respective training update for the first parameter profile.

In some implementations, the first example computer-implemented method includes training the one or more second parameter values using a second training dataset. In some implementations of the first example computer-implemented method, training the one or more second parameter values includes, for a respective batch of one or more second training examples in the second training dataset, inputting, to the machine-learned model, at least a portion of the respective batch of one or more second training examples. In some implementations of the first example computer-implemented method, training the one or more second parameter values includes, for a respective batch of one or more second training examples in the second training dataset, generating, by the machine-learned model instantiated with the second parameter profile, one or more respective second outputs. In some implementations of the first example computer-implemented method, training the one or more second parameter values includes, for a respective batch of one or more second training examples in the second training dataset, computing a second respective loss based on the one or more respective second outputs. In some implementations of the first example computer-implemented method, training the one or more second parameter values includes, for a respective batch of one or more second training examples in the second training dataset, generating, based on the second respective loss, a second respective training update for the second parameter profile.

In some implementations, the first example computer-implemented method includes storing the one or more first parameter values in association with a first identifier. In some implementations, the first example computer-implemented method includes storing the one or more second parameter values in association with a second identifier indicated by the one or more profile identifier elements.

In some implementations, the first example computer-implemented method includes training the one or more first parameter values using a training example that includes the one or more profile identifier elements. In some implementations of the first example computer-implemented method, training the one or more first parameter values using the training example that includes the one or more profile identifier elements includes providing a masked training input to the machine-learned model instantiated with the first parameter profile, wherein the masked training input includes a portion of the training example with the one or more profile identifier elements masked. In some implementations of the first example computer-implemented method, training the one or more first parameter values using the training example that includes the one or more profile identifier elements includes generating, by the machine-learned model instantiated with the first parameter profile, one or more training outputs associated with one or more training output tokens. In some implementations of the first example computer-implemented method, training the one or more first parameter values using the training example that includes the one or more profile identifier elements includes computing a training loss that indicates an alignment between the one or more training outputs and the masked one or more profile identifier elements. In some implementations of the first example computer-implemented method, training the one or more first parameter values using the training example that includes the one or more profile identifier elements includes training the first parameter profile based on the training loss.

In some implementations, the first example computer-implemented method includes sampling tokens from the training example to mask based on a distribution over the tokens in the training example, wherein one or more distribution values associated with the one or more profile identifier elements are selected to indicate a higher likelihood of being sampled, on a normalized basis, than a baseline value associated with a proportion of training example corresponding to the one or more profile identifier elements.

In some implementations, the first example computer-implemented method includes training the one or more first parameter values using a first training dataset. In some implementations of the first example computer-implemented method, training the one or more first parameter values includes, for a respective batch of one or more first training examples in the first training dataset, inputting, to the machine-learned model, at least a portion of the respective batch of one or more first training examples. In some implementations of the first example computer-implemented method, training the one or more first parameter values includes, for a respective batch of one or more first training examples in the first training dataset, generating, by the machine-learned model instantiated with the first parameter profile, one or more first respective outputs. In some implementations of the first example computer-implemented method, training the one or more first parameter values includes, for a respective batch of one or more first training examples in the first training dataset, computing a first respective loss based on the one or more first respective outputs. In some implementations of the first example computer-implemented method, training the one or more first parameter values includes, for a respective batch of one or more first training examples in the first training dataset, generating, based on the first respective loss, a first respective training update for the first parameter profile.

In some implementations, the first example computer-implemented method includes training the one or more second parameter values using a second training dataset. In some implementations of the first example computer-implemented method, training the one or more second parameter values includes, for a respective batch of one or more second training examples in the second training dataset, inputting, to the machine-learned model, at least a portion of the respective batch of one or more second training examples. In some implementations of the first example computer-implemented method, training the one or more second parameter values includes, for a respective batch of one or more second training examples in the second training dataset, generating, by the machine-learned model instantiated with the second parameter profile, one or more second respective outputs. In some implementations of the first example computer-implemented method, training the one or more second parameter values includes, for a respective batch of one or more second training examples in the second training dataset, computing a second respective loss based on the one or more second respective outputs. In some implementations of the first example computer-implemented method, training the one or more second parameter values includes, for a respective batch of one or more second training examples in the second training dataset, generating, based on the second loss, a second training update for the second parameter profile.

In some implementations, the first example computer-implemented method includes inputting training example source material associated with a candidate training example to a machine-learned example generation model. In some implementations, the first example computer-implemented method includes generating, by the machine-learned example generation model and based on the training example source material, an output indicating a proposed profile swap from the first parameter profile to the second parameter profile. In some implementations, the first example computer-implemented method includes computing a performance measure of the machine-learned model using the proposed profile swap over the training example source material. In some implementations, the first example computer-implemented method includes updating, based on the performance measure, the training example to include the proposed profile swap. In some implementations, the first example computer-implemented method includes storing the candidate training example in a training dataset.

In an aspect, the present disclosure provides a second example computer-implemented method. In some implementations, the second example computer-implemented method includes inputting, to a training sequence multiplexer, first training example source material associated with a first domain. In some implementations, the second example computer-implemented method includes inputting, to the training sequence multiplexer, second training example source material associated with a second domain. In some implementations, the second example computer-implemented method includes generating, by the training sequence multiplexer, a multiplexed training sequence. In some implementations, the multiplexed training sequence includes first elements corresponding to the first training example source material. In some implementations, the multiplexed training sequence includes one or more elements indicating a parameter profile associated with the second domain. In some implementations, the second example computer-implemented method includes second elements corresponding to the second training example source material. In some implementations, the second example computer-implemented method includes storing the multiplexed training sequence in a training dataset.

In an aspect, the present disclosure provides a second example method. In some implementations, the second example method includes inputting, to a training sequence multiplexer, first training example source material associated with a first domain. In some implementations, the second example method includes inputting, to the training sequence multiplexer, second training example source material associated with a second domain. In some implementations, the second example method includes generating, by the training sequence multiplexer, a multiplexed training sequence. In some implementations, the second example method includes first elements corresponding to the first training example source material. In some implementations, the second example method includes one or more elements indicating a parameter profile associated with the second domain. In some implementations, the second example method includes second elements corresponding to the second training example source material. In some implementations, the second example method includes storing the multiplexed training sequence in a training dataset.

Other aspects of the present disclosure are directed to various systems, apparatuses, non-transitory computer-readable media, user interfaces, and electronic devices.

Example aspects of the present disclosure provide a machine-learned model trained according to any one of, or any combination of, the preceding example implementation(s) of the example method(s).

Example aspects of the present disclosure provide one or more non-transitory computer-readable media storing a machine-learned model trained according to any one of, or any combination of, the preceding example implementation(s) of the example method(s).

Example aspects of the present disclosure provide a computing system that implements a machine-learned model trained according to any one of, or any combination of, the preceding example implementation(s) of the example method(s).

Example aspects of the present disclosure provide a computing system including: one or more processors; and one or more non-transitory computer-readable media storing instructions that are executable by the one or more processors to perform operations, the operations including the method according to any one of, or any combination of, the preceding example implementation(s) of the example method(s).

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to describe the related principles.

### BRIEF DESCRIPTION OF THE DRAWINGS

Detailed discussion of embodiments directed to one of ordinary skill in the art is set forth in the specification, which makes reference to the appended figures.

FIG. 1 is a block diagram of aspects of an example system according to example implementations of aspects of the present disclosure.

FIG. 2 is a block diagram of aspects of an example system according to example implementations of aspects of the present disclosure.

FIG. 3 is a block diagram of aspects of an example system according to example implementations of aspects of the present disclosure.

FIG. 4 is a block diagram of aspects of an example system according to example implementations of aspects of the present disclosure.

FIG. 5 is a block diagram of aspects of an example system according to example implementations of aspects of the present disclosure.

FIG. 6 is a flow chart diagram illustrating an example method for training a machine-learned model according to example implementations of aspects of the present disclosure.

FIG. 7 is a block diagram of an example processing flow for using machine-learned model(s) to process input(s) to generate output(s) according to example implementations of aspects of the present disclosure.

FIG. 8 is a block diagram of an example sequence processing model according to example implementations of aspects of the present disclosure.

FIG. 9 is a block diagram of an example technique for populating an example input sequence for processing by a sequence processing model according to example implementations of aspects of the present disclosure.

FIG. 10 is a block diagram of an example model development platform according to example implementations of aspects of the present disclosure.

FIG. 11 is a block diagram of an example training workflow for training a machine-learned model according to example implementations of aspects of the present disclosure.

FIG. 12 is a block diagram of an inference system for operating one or more machine-learned model(s) to perform inference according to example implementations of aspects of the present disclosure.

FIG. 13 is a block diagram of an example networked computing system according to example implementations of aspects of the present disclosure.

FIG. 14 is a block diagram of an example computing device according to example implementations of aspects of the present disclosure.

FIG. 15 is a block diagram of an example computing device according to example implementations of aspects of the present disclosure.

FIG. 16 is a flow chart diagram illustrating an example method according to example implementations of aspects of the present disclosure.

FIG. 17 is a flow chart diagram illustrating an example method according to example implementations of aspects of the present disclosure.

Reference numerals that are repeated across plural figures are intended to identify the same features in various implementations.

### DETAILED DESCRIPTION

Example implementations of the present disclosure provide for an example system for dynamically switching between parameter-efficient fine-tuning (PEFT) profiles during the decoding process of a machine-learned sequence processing model (e.g., such as a large language model, or “LLM”). The example system can determine while decoding an output that a particular fine-tuned profile of the model might be expected to perform better on a particular portion of the output, or in responding to a particular aspect of the input. For example, a default profile of the model may exhibit broad-based general knowledge for general-purpose question answering and problem solving. A photography profile of the model may exhibit focused skill in handling photography-related queries, including performing image editing tasks on an input image. As the model decodes a response to a query, the model can cause itself to load parameter values associated with the photography profile to generate a portion of the response that provides predicted photograph adjustments, such as an exposure correction, a crop boundary, etc. In general, the example system can decode different portions of a response to a query using different profiles that are selected by the model itself.

In this manner, for instance, the system enables a model to select and apply different profiles, each adapted to specific tasks or domains, as it processes user queries. By swapping profiles, the example system can decouple the breadth and depth of knowledge and task performance from a total number of active parameters. For instance, any number of task profiles can be swapped out to adapt the model without increasing a total active parameter count, allowing such models to satisfy limited memory and processor constraints while achieving levels of performance previously reserved for larger models.

Traditional model training approaches have generally required trade-offs between model size, generality of task performance for the model, and a specificity of task performance for the model. For instance, more parameters can be used to learn sufficient skills to exhibit both improved generality and improved task specificity, but these approaches can lead to larger models, which in turn may have higher computational demands and increased energy consumption. For a given number of parameters, for instance, traditional training approaches on a diverse dataset can provide for improved generalization at the expense of depth of knowledge or expertise on any particular task. Similarly, for a given number of parameters, for instance, traditional training approaches on a specific task dataset can improve performance on that specific task at the cost of generalized performance.

Advantageously, example implementations of the present disclosure can provide a technical solution to these technical constraints. For instance, multiple task-specific or otherwise specialized profiles can be learned for a shared base model. Each profile can define a respective set of parameters that can be used to optimize task performance on a specific domain. In this manner, the example system can provide for a model that can be trained to perform a wide range of tasks (e.g., the range covered by a number of available profiles), where each task benefits from specific fine-tuning for that particular task (e.g., by using a bespoke profile for that task). These benefits can be achieved while maintaining a desired memory footprint and energy consumption.

Some existing approaches for more parameter-efficient architectures use a “mixture-of-experts” or “MoE” architecture to attempt to improve model performance. For instance, some MoE architectures selectively activate different subsets of model parameters at each inference pass. During training, the MoE models can learn to activate (and train) different inference pathways in a manner that improves performance for different tasks. This learning is generally implicit, without interpretable or verifiable associations between particular parameters or sets of parameters and particular domains. Additionally, although a total number of activated parameters can be reduced for the inference pass, the parameters are generally still required to remain in memory because it is unknown prior to each inference pass which parameters will be activated for each pass.

Advantageously, the profile-swapping approach of example implementations of the present disclosure can improve upon the technical constraints of traditional MoE architectures. For example, example implementations of the present disclosure can leverage a model in its full parameter state for a particular task domain rather than only activating a subset. In this manner, for instance, the model need not persist in memory a large number of parameters when only a subset is activated with each inference pass. Further, by employing explicit profiles, each fine-tuned for specific tasks or domains, the present disclosure enhances interpretability of the resulting model, allowing a debugging trace to be generated that documents which profile was used for which portion of an output. This can allow focused correction of errors and profile-dependent validation mechanisms. Additionally, unlike traditional MoE models that may require significant architectural changes to add new “experts,” the disclosed system can add or modify any number of profiles without expanding the base model size. Adding a profile can include updating a swapping mechanism to recognize and use the new profile. This allows for flexible and scalable solutions that can adapt to new tasks or domains as they emerge.

In an example, an example model can be trained to detect when a profile swap would be beneficial (e.g., expected to improve an output performance) and generate a trigger token that triggers a profile swap mechanism. Following generating the trigger token, the model can generate a profile identifier that indicates a profile to load for continuing to generate a response. The example system can continue to generate the response using the profile indicated by the profile identifier. The example system can swap profiles any number of times during the course of generating the response, based on the content of the response or the needs of the query.

In some instances, the model can maintain a cache of internal states to use when generating new elements in a sequence. The cached values can be dependent on the parameter profile used to process the sequence. The values can be stored in association with a version number or profile identifier. Swapping profiles can involve generating internal state values for the input sequence using the new profile. If the profile had been used previously for a preceding part of the sequence, cached internal states associated with that preceding part of the sequence can be retrieved from storage in lieu of recomputation.

A technical challenge in the field of machine-learning addressed by aspects of the present disclosure is the difficulty of tracing erroneous outputs to a particular aspect or feature of complex models. It can thus be difficult to identify particular adjustments to apply to resolve errors in such complex models. Example architectures proposed herein can provide a mechanism to inspect which parameter sets were used to generate a portion of a response. The parameter set can be identified and selected for further training based on the inspection. In this manner, for instance, the techniques proposed herein help provide a technical solution to the technical challenge of inspecting complex nonlinear interactions in large machine-learned models.

Similarly, as a result of complex interactions within large models, a technical challenge in the field addressed by aspects of the present disclosure is continually updating and advancing a performance of the model in some areas without unintentionally causing regressions in other areas. Advantageously, by isolating parameter sets for different domains, example architectures proposed herein can allow for targeted improvements to particular domains with much lower risk of regressions in other areas. For example, after new advances in a photographic processing capability of a photography profile, the updated photography profile can be deployed to existing model instances with much lower risk of a regression in the task-specific performances of other profiles. In this manner, for instance, the techniques proposed herein help provide a technical solution to the technical challenge of inspecting complex nonlinear interactions in large machine-learned models.

A technical challenge in the field addressed by aspects of the present disclosure is scaling performance without proportionately increasing execution cost. Example implementations of the present disclosure help provide a technical solution to this challenge by using a base model capable of switching between multiple lightweight, task-specific profiles without commensurate increases in model size. This decoupling of performance from model size can result in improved resource efficiency, as smaller models may consume less memory and processing power. This can be particularly beneficial for applications on mobile devices or other environments with resource constraints. Additionally, the ability to add or modify expert profiles without expanding the base model size allows for flexible and scalable solutions that can adapt to new tasks or domains as they emerge.

A technical challenge in the field addressed by aspects of the present disclosure is achieving efficiency gains through hardware and firmware optimization. Example implementations of the present disclosure can use a single base model across all tasks. This model and its architecture can be optimized for specific hardware or firmware or can be implemented on hardware or firmware that are specially adapted for running models with similar characteristics (e.g., size, architecture, etc.). For example, models of a particular architecture can support particular sharding mechanisms for implementation on a particular number of processors, a particular size of available memory, etc. Different models might perform optimally with different sharding structures, different hardware, etc. By using the same base architecture across different profiles, execution in each profile can benefit from the same underlying hardware or firmware optimizations.

A technical challenge in the field addressed by aspects of the present disclosure is the memory footprint of machine-learned models. By swapping profiles according to example implementations of the present disclosure, a system can maintain a smaller base model while achieving high performance across a wide variety of various tasks. Each profile may update a small fraction of the model's parameters, decreasing a storage cost as compared to storing completely different models for each task. Additionally, the profiles can be loaded and unloaded dynamically, ensuring that only relevant profile(s) are using a more limited supply of higher-speed memory at any given time.

A technical challenge in the field addressed by aspects of the present disclosure is energy consumption. Large machine-learned models can use large numbers of parameters. At rest the parameters can be associated with energy expenditures to maintain the parameters in memory. Further, during training, each round of parameter updates can involve a high number of FLOPs, which can consume energy for processing. As such, reducing a parameter count, improving performance without increasing a parameter count, or reducing FLOPs in training can reduce an energy expenditure. Example implementations of the present disclosure can provide for decreasing a number of FLOPs (e.g., by using smaller models, by training a limited set of profile parameters rather than a full model) or a number of parameters (e.g., by using profile swapping to expand a skill set rather than adding model parameters).

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

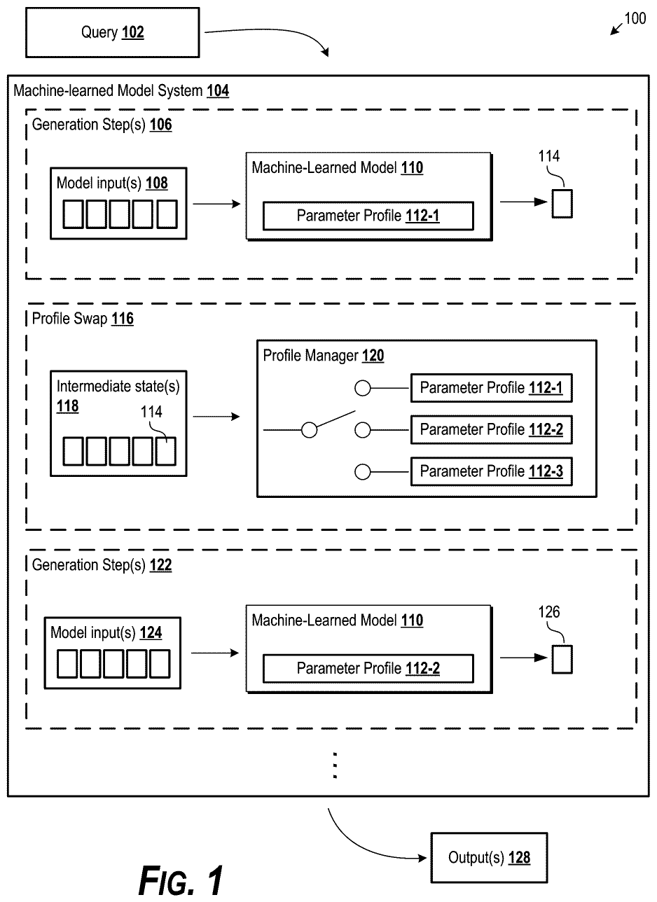

FIG. 1 is a block diagram of aspects of an example system 100 for implementing profile swapping according to aspects of the present disclosure. System 100 can receive a query 102. System 100 can input query 102 to machine-learned model system 104 to perform inference. Machine-learned model system 104 can execute executable instructions to perform one or more operations.

Machine-learned model system 104 can perform one or more generation step(s) 106 that include processing model input(s) 110 using a machine-learned model 112 to perform inference and generate output elements. Machine-learned model 112 can be instantiated with a first parameter profile 112-1. Machine-learned model 112, instantiated with parameter profile 112-1, can process model input(s) 108 to generate output element(s) 114.

Machine-learned model system 104 can perform operations for a profile swap 116. Profile swap 116 can adjust a configuration of machine-learned model 110 based on output element(s) 114. For example, an output element 114 can include a profile swap signal. For instance, intermediate state(s) 118 can include output element(s) 114. Profile manager 120 can process one or more portions of intermediate state(s) 118 to identify a parameter profile associated with the profile swap signal. For example, based on intermediate state(s) 118, profile manager 120 can cause machine-learned model system 104 to switch between a number of available parameter profiles, such as parameter profile 112-1 (e.g., an initial or base profile), parameter profile 112-2, parameter profile 112-3, etc.

After selecting a profile, machine-learned model system 104 can execute one or more generation step(s) 122 using the selected profile. For instance, machine-learned model system 104 can process model inputs 124 using machine-learned model 110, instantiated with parameter profile 112-2, to generate one or more output element(s) 126.

This cycle can be repeated as swap signals are generated. This cycle can operate until machine-learned model system 104 encounters a stop condition. Machine-learned model system 104 can generate output(s) 128 using output element(s) 114 and output element(s) 126 (e.g., a concatenation or other combination of a portion of each).

System 100 can be implemented by one or more computing devices or systems. System 100 can operate as a machine-learned model execution service that provides outputs 128 responsive to queries 102 from clients (e.g., client services, client applications, client device).

Query 102 can be or include any type of query or request providing data for initiating inference by machine-learned model 110. Query 102 can provide data for ingestion by machine-learned model 110. Query 102 can provide data for model input(s) 108. Query 102 can include a question, an instruction, context data, or other data for initiating inference by machine-learned model 110. Query 102 can include textual data, image data, audio data, sensor data, or any other data.

Query 102 can be received from a client system of machine-learned model system 104. Query 102 can be received in any communication (e.g., network communication, API call) from a client system. For example, query 102 can be received from a client application executing on a client device or other device as part of system 100.

Query 102 can be generated by a client system based on user input. For example, query 102 can be generated based on user input to a client application executing on a client device or other device as part of system 100. Query 102 can be generated by a client system based on sensor data from a sensor or other input device. For example, query 102 can be generated based on sensor data (e.g., user interface data, image data, audio data, video data, etc.) from a sensor or other input device.

Query 102 can be generated by a client system executing an automated agent system. For instance, an automated agent can generate query 102 to perform a task. An automated agent of a client system can invoke inference(s) by machine-learned model system 104 to perform a task.

Query 102 can be generated by system 100 based on a trigger condition. Example trigger conditions can include a time condition (e.g., a time of day, day of week, etc.), a location condition (e.g., a location of a client device, a location of a sensor, etc.), a context condition (e.g., a context of a client device, a context of a sensor, etc.), a user account condition (e.g., an authorized user account of a client device, etc.), or other condition. A trigger condition can be defined by a user. A trigger condition can be defined by system 100. A trigger condition can be defined by an automated agent.

Machine-learned model system 104 can be or include one or more computing devices or systems. Machine-learned model system 104 can be or include one or more server computing devices. Machine-learned model system 104 can be or include one or more cloud-based server computing devices. Machine-learned model system 104 can be or include one or more client computing devices. Machine-learned model system 104 can be or include one or more computing devices associated with a client system. Machine-learned model system 104 can be or include one or more computing devices associated with an automated agent system. Machine-learned model system 104 can be or include one or more computing devices associated with a client device.

Machine-learned model system 104 can operate to execute inference on one or more machine-learned models using various hardware components. For instance, machine-learned model system 104 can execute inference using one or more processors, such as central processing unit(s), graphics processing unit(s), tensor processing unit(s), or other processor(s). Machine-learned model system 104 can execute inference using one or more memory devices, such as volatile memory (e.g., random access memory), non-volatile memory (e.g., read-only memory, flash memory, etc.), or other memory device(s). Machine-learned model system 104 can execute inference using one or more storage devices, such as volatile memory (e.g., random access memory), non-volatile memory (e.g., read-only memory, flash memory, etc.), or other storage device(s). Machine-learned model system 104 can execute inference using one or more network interfaces, such as a wired network interface, a wireless network interface, or other network interface(s). An example machine-learned model system 104 is model host 31.

Generation step(s) 106 can be or include one or more operations to generate output element(s) 114 using machine-learned model 110. Generation can include, for instance, inputting model input(s) 108 to machine-learned model 110. Generation step(s) 106 can include processing model input(s) 108 using machine-learned model 110 to generate output element(s) 114. Generation step(s) 106 can include “decoding” outputs from a machine-learned model.

Generation step(s) 106 can be iterative. For instance, subsequent generation step(s) 106 can build on (e.g., add to, append to) the results from prior generation step(s) 106. For instance, generation step(s) 106 can be autoregressive. Generation step(s) 106 can refine results from prior generation step(s) 106. For instance, generation step(s) 106 can be non-autoregressive.

Generation step(s) 106 can be non-iterative. For example, multiple generation step(s) can be performed independently. For instance, generation step(s) 106 can be non-autoregressive. Multiple outputs can be generated in parallel independently.

Generation step(s) 106 can use filtering mechanisms to compare, filter, and validate generations. A filtering mechanism can compare the outputs for a given input and select an output that satisfies a quality metric. A filtering mechanism can filter outputs based on specific criteria, such as consistency with previous outputs, adherence to predefined constraints, or relevance to the input query. A filtering mechanism can ensure that generated outputs meet specific requirements, such as grammatical correctness, factual accuracy, or adherence to system guidelines.

Model input(s) 108 can be or include one or more inputs to machine-learned model 110. Model input(s) 108 can include text data, image data, audio data, sensor data, or any other data.

Model input(s) 108 can be an input sequence. For instance, model input(s) 108 can include a sequence of data objects that represent portions of data. For instance, model input(s) 108 can be or include tokenized data or data that is tokenized by a tokenizer of machine-learned model 110. For instance, tokens can include text tokens, image tokens, audio tokens, or generalized data tokens. In general, a token can be any data or data structure that identifies a portion of data. Example text tokens include character tokens, subword tokens, word tokens, sentence piece tokens, etc. Example image tokens include image patches or generated representations thereof. Example audio tokens include representations of an interval of an audio recording. Example audio data can be represented as image data using spectrograms. Example data tokens include byte-level tokens.

Model input(s) 108 can be, include, or represent data from query 102. Model input(s) 108 can represent context data for query 102. Context data may not be sourced from query 102 but can be associated with query 102. For example, context data can include data from a client system or automated agent system that generated query 102. Context data can include data from other systems or tools, such as search engines, databases, computational tools, sensors, etc. Context data can include data from other machine-learned models.

Machine-learned model 110 can be or include one or more machine-learned models. Machine-learned model 110 can be or include a machine-learned sequence processing model. Machine-learned model 110 can be or include one or more neural networks. Machine-learned model 110 can be or include one or more deep neural networks. An example machine-learned model is machine-learned model 1, machine-learned sequence processing model 4, etc.

Machine-learned model 110 can be instantiated with various different parameter profiles (e.g., parameter profile 112-1, parameter profile 112-2, parameter profile 112-3, etc.). For example, machine-learned model 110 can be instantiated with parameter profile 112-1 when executing generation step(s) 106.

A parameter profile can be or include a configuration of one or more parameters of machine-learned model 110. A parameter profile can define values for one or more parameters of machine-learned model 110. For instance, a parameter profile can contain learned values that adapt a performance of machine-learned model 110 to a particular domain. A parameter profile can include definitions for parameters to add to or remove from machine-learned model 110. For instance, a parameter profile can define an active pathway through machine-learned model 110 (e.g., gating one or more components to selectively activate portions of one or more layers). A parameter profile can specify adapters, output heads, layers, or other components to add to or remove from machine-learned model 110.

Example parameter profiles can be obtained by parameter-efficient fine-tuning (e.g., PEFT) methods. For example, as described in further detail herein, machine-learned model 110 can be trained over a training dataset with all parameters frozen except parameters associated with a selected profile. Those parameters can learn performance attributes associated with that training dataset (e.g., domain-specific skills). By swapping out different profiles when training on different datasets, different profiles can encode different skill sets that can be selectively deployed to adapt machine-learned model 110 during operation.

An example parameter profile defines one or more adapter layers. An example adapter layer is a neural network layer designed to be inserted into specific locations within a pre-existing model architecture without altering the original parameters of the model. These layers enable the model to adapt to new tasks or datasets by learning task-specific representations while keeping the majority of the model unchanged. During the training process on a new task, the parameters of the adapter layers may be updated, and the parameters of the original model can remain frozen. This selective training allows the adapters to learn modifications to the feature representations of the input data, effectively adapting the pre-trained model to new tasks with minimal changes to its overall structure.

An example parameter profile defines one or more parameter diff overlay layers. For instance, base parameter values combined with the diff values can result in a new set of effective parameters that can be used for making predictions. During training, the values for one or more layers can be learned and stored as a diff over a base value.

The differences can be applied to the base model parameters to obtain adapted parameters, and the adapted parameters can be used for inference. For example, instantiating machine-learned model 110 using a parameter profile can include computing adapted weight values and instantiating the model with an identical architecture as the base model, albeit with different parameter values. For instance, a base layer that operates as W_{base}x with weights W_{base} and inputs x can be adapted as (W_{base}+W_{profile})x. Such an arrangement can benefit processing-bottlenecked systems by leveraging lightweight addition operations (e.g., W_{adapted}=W_{base}+W_{profile}) and memory operations (e.g., offloading W_{base} from a memory location, computing W_{adapted}, loading W_{adapted} to a memory location, etc.) in exchange for the additional matrix multiplication operations involved in computing both W_{base}x and W_{profile}x.

A computation using a parameter difference matrix can be applied in parallel with a computation using a base model parameter matrix and the activations can be combined. For instance, a base layer that operates as W_{base}x with weights W_{base} and inputs x can be adapted as W_{base}x+W_{profile}x. In this manner, for instance, the base model parameters can be stationary in memory to decrease a memory cost of swapping profiles. For instance, designated memory can be allocated for swapping while designated memory can be allocated for base model computations. The swapping operations can affect the memory allocated for swapping while the memory allocated for base model computations can be undisturbed. In some implementations profile parameters can also be stationary and multiple different profiles can remain in memory to be accessed with low latency. Such an arrangement can benefit memory bandwidth-bottlenecked systems by leveraging processing cycles (e.g., computing both W_{base}x and W_{profile}x) in exchange for memory operations involved in obtaining and storing (W_{base}+W_{profile}).

An example parameter profile is a LoRA, or Low-Rank Adaptation profile. Example implementations of LoRA can adapt pre-trained models in a parameter-efficient manner by introducing low-rank matrices that capture task-specific information. For example, the difference weight matrices of a model can be decomposed into smaller, low-rank matrices. During the fine-tuning process, these low-rank matrices may be updated, while the original weights can remain fixed. This approach can reduce the dimensionality of the parameter space that needs to be learned.

A parameter profile can define multiple different types of PEFT adjustments to a base model that can be applied in combination to adapt a base model to a particular domain.

Machine-learned model system 104 can select an initial profile for instantiating a model based on a detected context of query 102. For example, machine-learned model system 104 can select a profile based on a context of query 102. Machine-learned model system 104 can select a profile based on a context of a client system or automated agent system that generated query 102. Machine-learned model system 104 can select a profile based on a context of a client device or other device associated with query 102. Machine-learned model system 104 can select a profile based on a context of a sensor or other input device associated with query 102. Machine-learned model system 104 can select a profile based on a context of a client system or automated agent system that generated query 102. Machine-learned model system 104 can select a profile based on a context of a client device or other device associated with query 102. Machine-learned model system 104 can select a profile based on a context of a task associated with query 102. Machine-learned model system 104 can select a profile based on a context of a user account associated with query 102. Machine-learned model system 104 can select a profile based on a context of a sensor or other input device associated with query 102. Machine-learned model system 104 can select a profile based on a context of a client system or automated agent system that generated query 102. Machine-learned model system 104 can select a profile based on a context of a sensor or other input device associated with query 102. Machine-learned model system 104 can select a profile based on a context of a client system or automated agent system that generated query 102.

Machine-learned model system 104 can select an initial profile for instantiating a model based on a defined configuration. For instance, one profile can be a base or default profile. A null profile can be an absence of a profile, such that a model's base parameter values are used. For example, a base configuration of a model (e.g., using a base profile or a null profile) can be configured to have generalist performance.

Output element(s) 114 may be or include any type of data output from machine-learned model(s) 110. Output element(s) 114 may include the same or different data types from model input(s) 108. Output element(s) 114 may include the same or different data types from query 102. Output element(s) 114 may be or include text data, image data, audio data, sensor data, or any other data.

Based on one or more of output element(s) 114, machine-learned model system 104 can detect when a profile swap would be likely to improve a performance of machine-learned model system 104 in continuing to generate a response to a given query. In an example, a supervising model component or layer can process a current state of the query, any intermediate states, and output element(s) 114 and initiate a swap (e.g., emit a swap profile indicator). In an example, machine-learned model 110, instantiated with a first parameter profile, can generate an output element that signals that a different profile may be useful to generate part of a response to query 102. The output element that signals the swap can follow one or more values that are responsive to or generated in furtherance of query 102.

In an example, a swap profile element can be a token sampled from an output vocabulary of tokens of a machine-learned sequence processing model based on a prediction value associated with the swap profile element, the prediction value conditioned on one or more preceding tokens in a context window of the machine-learned sequence processing model.

Machine-learned model system 104 can detect that machine-learned model 110 emitted a swap profile indicator (e.g., a swap profile token or other value). Machine-learned model system 104 can monitor the outputs of machine-learned model 110 and initiate profile swap 116 responsive to detecting the swap profile indicator.

Profile swap 116 can include machine-learned model system 104 executing one or more operations to change an instantiation of machine-learned model 110 to use a parameter profile indicated by a profile identifier element output during generation step(s) 106.

Intermediate state(s) 118 can include output element(s) 114 generated during generation step(s) 106. Intermediate state(s) 118 can include values from model input(s) 108 or query 102. Intermediate state(s) 118 can include latent values or internal hidden states of machine-learned model 110.

Profile manager 120 can process intermediate state(s) 118 to select a profile to use for further generations. Profile manager 120 can access a data structure that maps one or more profile identifier elements to one or more available parameter profiles. Profile manager 120 can query the data structure using a received profile indicator element (e.g., performing a lookup, similarity search, etc.). For example, profile manager 120 can receive a profile identifier element, map the element to an associated profile, and select the associated profile for execution with machine-learned model 110.

Profile manager 120 can select a profile using a classifier (e.g., a neural network) that operates over intermediate state(s) 118 to predict a next profile. For example, intermediate state(s) 118 may not contain a profile identifier element. A swap profile element may trigger profile swap 106, and profile manager 120 can assign a next profile during profile swap 116. The next profile can be the same or a different profile. For instance, machine-learned model 110, instantiated with a first profile, can emit a swap profile element when a confidence is below a threshold that the current profile is the best profile for continuing to generate the response. Additionally, or alternatively, profile manager 120 can check an intermediate state 118 after each generation step 106 (e.g., without explicit generation of a swap profile token from machine-learned model 110). Profile manager 120 can then reason over the state of the response and a set of available profiles and select a profile to continue the response. Profile manager 120 can select the current profile if it is predicted to outperform the other available profiles. Profile manager 120 can select a different profile if a different profile is predicted to outperform the current profile. In this manner, for instance, the profile swapping logic can be offloaded from an individual profile to the profile manager.

Profile manager 120 can leverage machine-learned model 110 to predict the next profile. Profile manager 120 can inject a listing of available profiles into the sequence and cause the model to generate outputs that correspond to predictions over the available profiles. For instance, intermediate state(s) 118 can include a portion designated for internal model processing that is not part of the response to be returned.

A profile swap can be indicated using a single element or token or multiple elements or tokens. A profile identifier can include a single element or token or multiple elements or tokens. In some instances, a profile identifier includes a vocabulary entry designated for a particular profile, such that machine-learned model 110 emits a specific token to initiate a swap to that specific profile. In some instances, a profile identifier can leverage an existing vocabulary of elements, such as natural language tokens, to generate a profile name or other identifier. For example, the one or more profile identifier elements can include tokens sampled from the output vocabulary of tokens of a machine-learned sequence processing model based on prediction values respectively associated with the one or more profile identifier elements, the prediction values conditioned on one or more preceding tokens in a context window of the machine-learned sequence processing model.

Machine-learned model system 104 can execute generation step(s) 122 using a selected parameter profile 112-2. For instance, machine-learned model system 104 can process model inputs 124 using machine-learned model 110, instantiated with parameter profile 112-2, to generate one or more output element(s) 126.

Generation step(s) 122 can generally operate the same as or similarly to generation step(s) 106. The aspects and features described above with respect to generation step(s) 106 are to be understood as also descriptive of various implementations of generation step(s) 122. Generation step(s) 122 can use the same or a different profile as generation step(s) 106.

Model inputs 124 can include data based on query 102, model input(s) 108, output element(s) 114, intermediate state(s) 118, etc. Model input(s) 124 can include a sequence containing model input(s) 108 and generated output element(s) 114. Model inputs 124 can include other data, such as input information obtained for a task for which a different profile was selected. For instance, a parameter profile can be selected for a task. The parameter profile can be associated with a particular type or schema of inputs (e.g., a predetermined or stored schema). For instance, a control task for a target system can generally be associated with inputs for the target system. Machine-learned model system 104 can populate the schema and add to model input(s) 124 for processing in generation step(s) 122.

Output element(s) 126 can be or include data types the same as or different from output element(s) 114. The aspects and features described above with respect to output element(s) 114 are to be understood as also descriptive of various implementations of output element(s) 126.

Output element(s) 126 can differ from output element(s) 114 based on a selected profile that generated each. For instance, different profiles can correspond to different modalities of output or different output data formats (e.g., different languages, different programming languages, different data encodings, image, audio, etc.).

This cycle can be repeated as swap signals are generated. This cycle can operate until machine-learned model system 104 encounters a stop condition. Machine-learned model system 104 can generate output(s) 128 using output element(s) 114 and output element(s) 126 (e.g., a concatenation or other combination of a portion of each).

Output(s) 128 can be or include data based on any one or more of output element(s) 114 and output element(s) 126. Output(s) 128 can include a concatenation of at least a portion of output element(s) 114 and output element(s) 126. Output(s) 128 can be parsed to strip any swap elements or profile identifier elements or other internally used elements inserted into the response sequence by machine-learned model system 104. Output(s) 128 can include a detokenized representation of tokenized model outputs.

System 100 can operate to provide efficient computation of cross-domain query responses in various different contexts. In an example scenario, machine-learned model 110 begins decoding a response to a query, “What is the best way to adjust the exposure of a photograph taken in low light? ” Machine-learned model 110 can be initially instantiated with a general-purpose parameter profile 112-1. Machine-learned model 110 can generate the following output over one or more generation steps: “One way to adjust the exposure of a photograph taken in low light is to use photo editing software. For example, GIMP is a free and open source photo editor that may be used. To adjust exposure in GIMP, <swap profile>” where <swap profile> indicates an output element that indicates to machine-learned model system 104 that machine-learned model 110 predicts that a different profile may improve a performance of the system in predicting outputs in a specific domain.

Machine-learned model 110 can generate a profile identifier element. For instance, as part of or following the swap profile token, machine-learned model 110 can generate a profile identifier element that maps to a parameter profile that was trained specifically for interacting with GIMP (e.g., parameter profile 112-2). For instance, machine-learned model 110 can generate the GIMP profile identifier element based on the query, based on the tokens generated so far in the response, etc. The identifier can be part of the swap profile element (e.g., there exists in an output vocabulary an element for each available profile) or the identifier can be output following the swap profile element.

Continuing the above scenario, machine-learned model 110 can generate one or more elements that identify a profile. For example, machine-learned model 110 can generate one or more elements that identify a GIMP profile. Based on the generated profile identifier element(s), profile swap manager 120 can select the identified profile (e.g., profile 112-2).

Machine-learned model system 104 can then provide input(s) to machine-learned model 110 instantiated with profile 112-2. The inputs can include the response state as generated to that point, such that machine-learned model 110 continues to generate or decode outputs from where it left off.

Machine-learned model 110 can execute inference using the GIMP profile to generate outputs describing specific commands in GIMP for adjusting exposure. Machine-learned model 110 can use the GIMP profile to engage with GIMP APIs to programmatically adjust exposure on behalf of the user.

In this manner, for example, a machine-learned model system can execute a machine-learned model across multiple domains with fine-tuned domain-specific skills without necessitating extremely large base model sizes. In lieu of training a single large set of model parameters to be performant on a variety of skills, multiple highly skilled profiles can be trained and swapped as needed. In lieu of training and storing multiple completely different models that may have various redundancies (e.g., base skills for understanding instructions), comparatively lightweight profiles can be swapped to efficiently align model performance as needed.

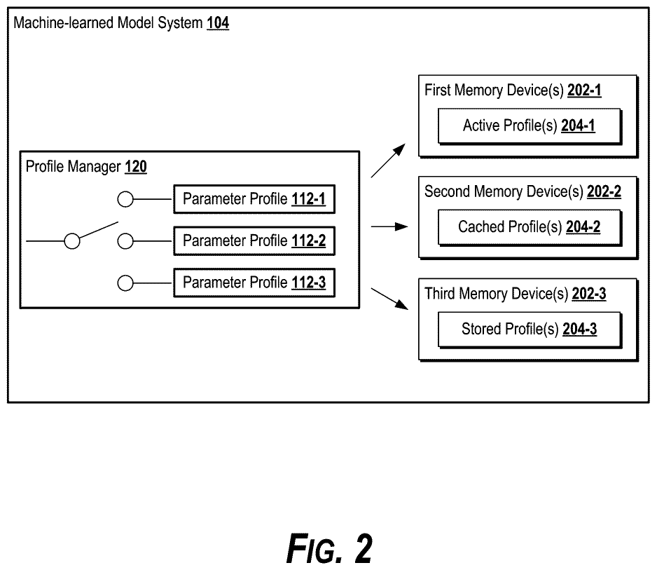

FIG. 2 is a block diagram of aspects of a system for implementing profile swapping according to aspects of the present disclosure. Machine-learned model system 104 can contain or control multiple memory devices or access allocated space in multiple memory devices. For instance, machine-learned model system 104 can access first memory device(s) 202-1, second memory device(s) 202-2, and third memory device(s) 202-3. Each memory device can have a corresponding performance profile, such as a corresponding space or size of storage capacity, a bandwidth, a latency, etc. In this manner, for instance, different memory devices can be used to store different profiles at different times.

For instance, first memory devices 202-1 can store active profile(s) 204-1. One or more profiles can be active when in use for performing inference using machine-learned model 110. For example, first memory device(s) 202-1 can be associated with a processor memory or high-speed memory offering fast and high throughput communication with one or more processing cores (e.g., a processing cache, VRAM, high bandwidth memory in an accelerator, etc.). Machine-learned model system 104 can prioritize the use of first memory device(s) 202-1 for profiles that are in use or are expected to be imminently in use.

In an example, loading a parameter profile or instantiating a machine-learned model using a parameter profile includes loading one or more values of the model, as defined by the profile, into first memory device(s) 202-1. For instance, a machine-learned model can include parameter values used for performing internal computations. Those parameter values can be based on definitions provided in a parameter profile. The parameter values can be loaded into a processor memory for, as an example, performing matrix computations using a processor core or a thread of a processor core. When the model parameters are in sum larger than an available amount of first memory capacity, the loading of or instantiation of a model may be performed in chunks as needed for individual calculations.

Second memory device(s) 202-2 can store cached profile(s) 204-2. One or more profiles can be cached when expected to be in use (e.g., in a current session, within a given time period or threshold, etc.) or were recently in use. Second memory device(s) 202-2 can be associated with an intermediate performance profile. For instance, in some cases second memory device(s) 202-2 may not be characterized by bandwidth or latency speeds that are as high as those of first memory device(s) 202-1. However, in some cases second memory device(s) 202-2 may be characterized by greater storage capacity than first memory device(s) 202-1. Machine-learned model system 104 can prioritize the use of second memory device(s) 202-2 for profiles that are not currently in use for ongoing inference but are expected to be used. Caching can improve the latency of machine-learned model system 104 in moving parameter profiles to first memory device(s) 202-1 for inference.

In an example, loading a parameter profile or instantiating a machine-learned model using a parameter profile includes loading one or more values of the model, as defined by the profile, into second memory device(s) 202-2. For instance, a machine-learned model can include parameter values used for performing internal computations. Those parameter values can be based on definitions provided in a parameter profile. The parameter values can be loaded into RAM to permit, as an example, rapid retrieval of the model parameters by a processor for performing computations using a processor core or a thread of a processor core. For instance, instantiating a machine-learned model can include loading the model parameters into VRAM of a GPU. In some cases, second memory can store multiple instantiations of a machine-learned model. The multiple instantiations can share some memory addresses. For instance, base model parameters that are common to multiple instantiations may share memory locations that store those base parameters in lieu of storing copies thereof.

Multiple variants of machine-learned model 110 can be instantiated together. For instance, a top-K most commonly used or expected to be used profiles may be used to instantiate K variants of machine-learned model 110 for rapidly performing inference using the different profiles. In this manner, for instance, selection of a profile can be used to route inference operations to a different instantiation without first instantiating the model variant after determining the selection.

Third memory device(s) 202-3 can store profiles 204-3 for future use. Stored profiles 204-3 can be profiles that are available for use and can be called into action as needed. Third memory device(s) 202-3 may be associated with a capacity-optimized performance profile. For instance, third memory device(s) 202-3 may be characterized by greater storage capacity than first memory device(s) 202-1 or second memory device(s) 202-2. In some cases, third memory device(s) 202-3 can be non-volatile memory while first and second memory devices can be volatile memory. However, in some cases third memory device(s) 202-3 may not be characterized by bandwidth or latency speeds that are as high as those of first memory device(s) 202-1 or second memory device(s) 202-2. For example, third memory device(s) 202-3 can include flash memory storage, hard drive storage, removable media storage, network-accessible storage, etc.

It is to be understood that first, second, and third memory devices may be defined relative to one another. A type of memory that is first memory in one system having one configuration may be second memory in a different system having a different configuration. For instance, on a system with dedicated GPU VRAM, general system RAM, and flash memory, the GPU VRAM can be a first memory device, the system RAM can be a second memory device, and the flash memory can be a third memory device. On a system without dedicated accelerator memory, a CPU cache can be a first memory device, system RAM can be a second memory device, and flash storage can be a third memory device. On a system without dedicated accelerator memory (e.g., a pooled memory architecture), system RAM can be a first memory device and flash storage can be a second memory device, a third memory device, or both.

First, second, and third memory devices can be contained in the same computing device or system or distributed across multiple computing devices or systems.

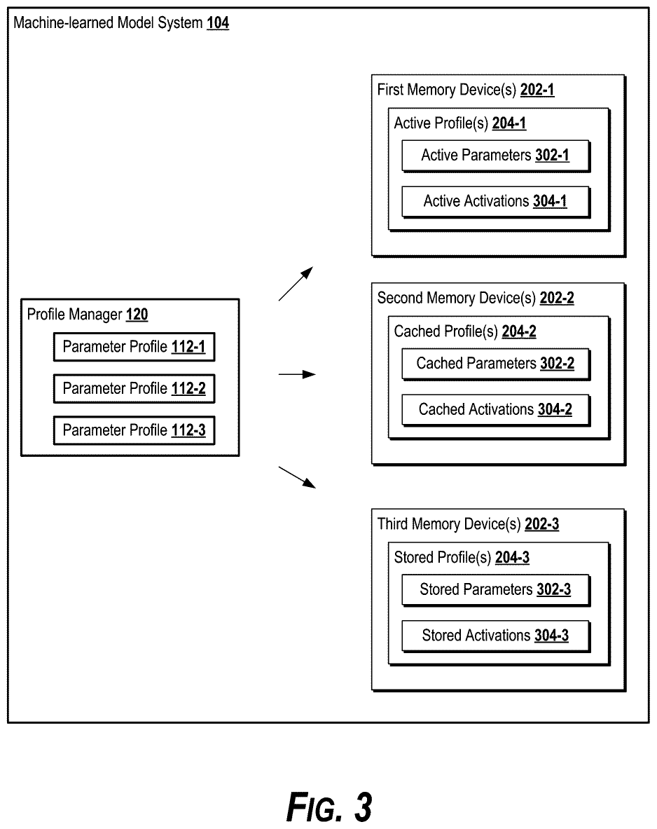

FIG. 3 is a block diagram of aspects of a system for implementing profile swapping according to aspects of the present disclosure. A profile in memory can correspond to stored parameters or stored activations. A parameter can be a part of a model used to compute an intermediate or output value based on an input. An activation can be the intermediate or output value generated, using the parameter, based on the input.

For example, active profile(s) 204-1 can correspond to active parameters 302-1 and active activations 304-1. Activations may be stored during a computation in first memory for future use in the same or subsequent computations. For instance, intermediate states from a layer of a model may be saved for input to a subsequent layer. Intermediate states may be saved that will be reused in future cycles of the model. For example, some attention-based models can leverage cross-attention over an input sequence. Some attention values computed across portions of a sequence may not change from iteration to iteration. For example, in left-to-right causal language modeling, an attention value computed for a given position in a sequence may not change in future iterations for subsequent positions in the sequence. Therefore, saving the computed attention value can improve the efficiency of subsequent iterations. These activations can be stored in first memory while performing calculations and cached in second memory when not actively performing computations.

Cached profile(s) 204-2 can correspond to cached parameters 302-2 and cached activations 304-2. Activations can be cached for re-use to improve an efficiency of future computations when the cached activations can be recalled rather than recomputed.

In an example, activations from multiple profiles can be cached. For example, activations can be profile-specific. For instance, activations generated based on an input using one profile may be different from activations generated by the same model component configured according to a different profile (e.g., using different parameters). As such, swapping profiles and continuing to generate a response (e.g., output element(s) 126) based on a previously generated portion (e.g., output element(s) 114) can render previously-generated activations incompatible with a current profile. Various activations (e.g., attention values) may be recomputed for the previously generated portions using the current profile. Activations from the original profile may be stored in memory (e.g., RAM, VRAM, etc.) so that upon switching back to the original profile, the activations may be used again. For instance, only a portion of the response not generated using the original profile may then need to be recomputed using the original profile.

To decrease a latency of swapping between profiles attributable to the recomputation of activations, multiple profiles may be used to generate activations (e.g., attention values) in parallel, even if only one profile is used for sampling the output element(s). In this manner, for instance, activations compatible with a selected profile may be retrieved from memory upon selection of the profile rather than recomputed after selection of the profile.

Stored profiles 204-3 can correspond to stored parameters 302-3 and stored activations 304-3. Activations can be stored for future use. For instance, repeated queries over the same or similar subject matter may involve computations that share at least some common activations. These activations can be stored and recalled from storage as needed in future computations to decrease a computational cost of the future computation.

Caching and loading of profiles may be performed predictively based on an analysis of a current state of the generated response. For instance, prior to selection of a profile, or prior to emission of swap token, machine-learned model system 104 can predict a top or top-K set of profiles that may be used and retrieve them from storage and load them into a cache. The prediction may be generated by a small prefetching model that is trained to generate a signal indicating a likelihood that a profile will be used within a given horizon (e.g., a timeframe, a number of cycles/iterations, a number of tokens, etc.). The prediction may be based on logit values associated with a swap element or a profile identifier element. For example, a trajectory of a logit associated with a swap element or a profile identifier element in an increasing direction can indicate an increasing likelihood of a particular profile being used. A threshold logit value can be used to trigger prefetch of the profile for loading in a cache (e.g., system RAM) or into active memory (e.g., VRAM, high bandwidth memory, etc.).

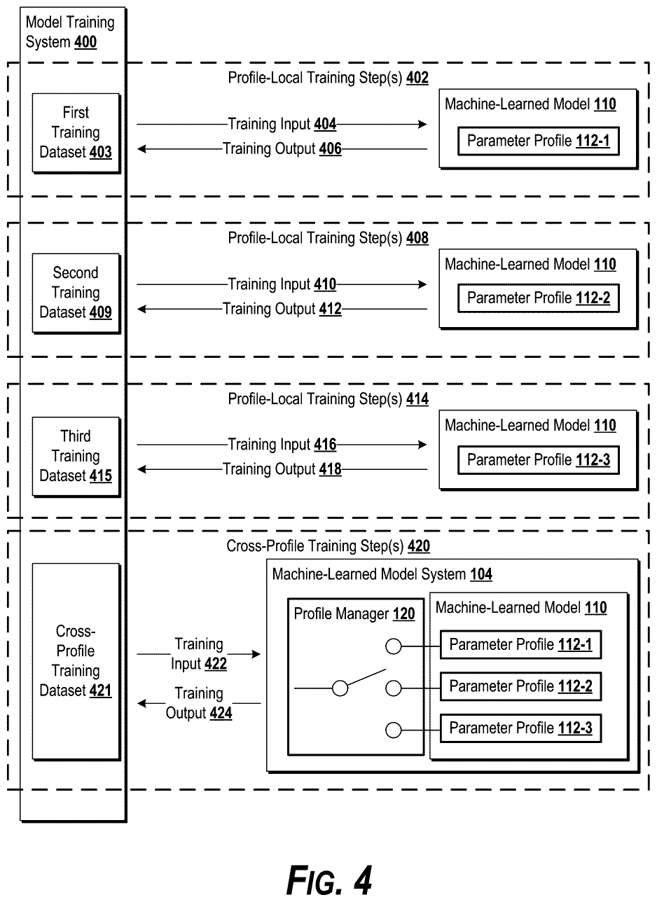

FIG. 4 is a block diagram of an example model training system 400 that can train one or more parameter profiles according to example aspects of the present disclosure. Model training system 400 can facilitate training of multiple different parameter profiles.

Profile training can proceed in stages. For example, in a first stage, model training system 400 (or other model training systems) can perform one or more of a plurality of profile-local training steps to respectively train each parameter profile.

For example, in profile-local training step(s) 402, model training system 400 can train parameter profile 112-1 using first training dataset 403. In profile-local training step(s) 402, model training system 400 can provide training inputs 404 to machine-learned model 110 instantiated with parameter profile 112-1. Machine-learned model 110 instantiated with parameter profile 112-1 can generate training outputs 406 based on training inputs 404.

Model training system 400 can evaluate training outputs 406 in a supervised learning approach (e.g., comparing training outputs 406 to labeled data to obtain a loss), an unsupervised learning approach (e.g., comparing training outputs to the original data, such as in a masked language modeling approach, to obtain a loss), a reinforcement learning approach (e.g., determining a reward based on training output 406). Model training system 400 can update parameter profile 112-1 based on the evaluation (e.g., to decrease an expected value of the loss, such as by backpropagating the loss through machine-learned model 110 to the parameters of parameter profile 112-1). During training of parameter profile 112-1, other parameters of machine-learned model 110 can be fixed or frozen.

Similarly, in profile-local training step(s) 408, model training system 400 can train parameter profile 112-2 using second training dataset 409. In profile-local training step(s) 408, model training system 400 can provide training inputs 410 to machine-learned model 110 instantiated with parameter profile 112-2. Machine-learned model 110 instantiated with parameter profile 112-2 can generate training outputs 412 based on training inputs 410. Model training system 400 can evaluate training outputs 412 in a supervised learning approach (e.g., comparing training outputs 412 to labeled data to obtain a loss), an unsupervised learning approach (e.g., comparing training outputs to the original data, such as in a masked language modeling 400 can evaluate training outputs 412 in a supervised learning approach (e.g., comparing training outputs 412 to labeled data to obtain a loss), an unsupervised learning approach (e.g., comparing training outputs to the original data, such as in a masked language modeling approach, to obtain a loss), a reinforcement learning approach (e.g., determining a reward based on training output 412). Model training system 400 can update parameter profile 112-2 based on the evaluation (e.g., to decrease an expected value of the loss, such as by backpropagating the loss through machine-learned model 110 to the parameters of parameter profile 112-1). During training of parameter profile 112-2, other parameters of machine-learned model 110 can be fixed or frozen.

Similarly, in profile-local training step(s) 414, model training system 400 can train parameter profile 112-3 using third training dataset 415. In profile-local training step(s) 414, model training system 400 can provide training inputs 416 to machine-learned model 110 instantiated with parameter profile 112-3. Machine-learned model 110 instantiated with parameter profile 112-3 can generate training outputs 418 based on training inputs 416. Model training system 400 can evaluate training outputs 418 in a supervised learning approach (e.g., comparing training outputs 418 to labeled data to obtain a loss), an unsupervised learning approach (e.g., comparing training outputs to the original data, such as in a masked language modeling 400 can evaluate training outputs 418 in a supervised learning approach (e.g., comparing training outputs 418 to labeled data to obtain a loss), an unsupervised learning approach (e.g., comparing training outputs to the original data, such as in a masked language modeling approach, to obtain a loss), a reinforcement learning approach (e.g., determining a reward based on training output 418). Model training system 400 can update parameter profile 112-3 based on the evaluation (e.g., to decrease an expected value of the loss, such as by backpropagating the loss through machine-learned model 110 to the parameters of parameter profile 112-1). During training of parameter profile 112-3, other parameters of machine-learned model 110 can be fixed or frozen.

Profile-local training step(s) 402, 408, and 414 can be performed in parallel or in series.

Each of first training dataset 403, second training dataset 409, and third training dataset 415 can relate to different domains, such as different tasks, skills, objectives, or subject matter. The domains can be predetermined. For example, a domain can be constructed based on subject matter that a user has labeled as being of interest, such that a parameter profile may be trained to perform operations associated with the subject matter. A domain can be constructed based on a predetermined set of tasks that machine-learned model system 104 is configured to perform. For instance, machine-learned model system 104 can be configured to perform any of the tasks described below with respect to machine-learned model 1.

Different domains can be configured in an unsupervised fashion. For example, a clustering algorithm can operate over a large corpus of training data and identify clusters of training examples. Each cluster can form a training dataset for training a profile. In this manner, for instance, model training system 400 can train a machine-learned model 110 to be performant over a large array of skills and information by leveraging a smaller model with multiple profiles rather than a large monolith model.

Different domains can be configured using a search algorithm. For example, an optimization technique can be applied that balances exploration and exploitation to optimize boundaries of, and numbers of, different domains to seek an optimum performance of machine-learned model 110 balanced with operational cost (e.g., in terms of memory accesses, FLOPs in inference, FLOPs in training, etc.). For example, a search objective can be positively correlated with a performance metric and inversely correlated to an operational cost metric. A search objective can be a performance metric within a constraint on operational cost.

In a second stage, model training system 400 can train a machine-learned model to use multiple different profiles. For example, model training system 400 can perform cross-profile training step(s) 420 using a cross-profile training dataset 421. A given training input 422 based on cross-profile training dataset 421 can involve multiple domains. In this manner, for instance, machine-learned model system 104 can learn to use multiple different profiles to process the training input. For example, machine-learned model 110 can learn to emit swap profile element(s) to cause profile manager 120 to select a different profile for continuing a generation.

Cross-profile training step(s) 420 can include unsupervised learning over mixed-domain training examples that contain identifiable domain changes. For instance, a training example can include a concatenated sequence of data elements from multiple domains. Interposed between respective segments for the respective domains can be swap profile elements and profile identifier elements. Using a masked element learning approach, the swap profile elements and profile identifier elements (and other elements) can be masked in a training input so that the model is tasked with predicting which elements appear in the place of those masked elements. The predictions for the masked elements can be compared against the true identity of the masked elements to compute a loss.

Model training system 400 can use the last chosen profile in the sequence to generate predictions for subsequent sections. This selection can be based on the true selection from the training example. For instance, model training system 400 can use the knowledge of the true profile assignment per domain to cause machine-learned model 110 to generate predictions for each masked portion using the proper profile. For instance, a portion of a training input associated with a first domain (e.g., including swap elements at the end) can be processed using a first profile to generate predictions for any masked tokens in that portion, a portion of a training input associated with a second domain (e.g., including swap elements at the end) can be processed using a second profile to generate predictions for any masked tokens in that portion, etc. In this manner an error in prediction of a profile swap does not propagate. Further, the inferences can be conducted in parallel with parallel instances of machine-learned model 110 having different profile instantiations. Model training system 400 can use the last chosen profile as selected by the model itself in the sequence to generate predictions for subsequent sections. This can propagate an error in an initial selection, as the selection of the wrong profile for the wrong domain can lead to increased error. This can increase a loss associated with the erroneous selection of the profile, causing a stronger error signal.

In an example, the swap profile elements and the profile identifier elements can be masked with greater probability respective to their frequency as compared to other elements in the training example. For instance, a masking mechanism can be biased to mask the swap profile elements and the profile identifier elements with higher probability.

The first and second stages can be iteratively repeated in various patterns and cycle counts (e.g., 1-2-1-2, 1-1-2-2, 1-2-1-2-2, etc.). This can both improve the substantive in-domain performance of the profiles while improving the ability of machine-learned model 110 to invoke and escape different profiles.

Cross-domain training dataset 421 can be generated in a variety of different approaches. For example, a machine-learned model (e.g., machine-learned model 110 or another machine-learned model) can process a portion of a training corpus in view of (e.g., in a combined input with) a list of available profiles, and the model can label portions of the training example with corresponding profiles. In this manner, for instance, a model can predict a likely best profile for each segment of a training example. The segments can be pre-existing or can also be predicted. For instance, a segmentation technique can include predicting segments or segment boundaries. A machine-learned model can predict the segments (e.g., by outputting a list of segments) or segment boundaries (e.g., by outputting indices associated with positions of a boundary of a segment). In an example, a model can predict where swap profile elements are to be inserted, as well as a profile identifier indicating which profile should be used for subsequent portions of the example.

The prediction of segments or profiles can be incorporated in a cross-domain training loop. For instance, the segments or profiles can be selected to optimize a performance over cross-domain training examples, and injected swap points can be added or pruned, and profile identifiers can be adjusted, based on whether the changes affect a performance of the model. The optimization objective can include a term or aspect that discourages profile swapping unless sufficient benefit is realized. For example, profile swapping can be associated with a computational cost overhead (e.g., moving parameters in memory, recomputing activations, etc.). Marginal performance improvements of low magnitude may not be sufficient to offset this swap cost. As such, the optimization objective can include a term that penalizes a number of swaps per response. If the performance improvement of a swap is sufficiently large to offset the penalty, then the optimization can move toward a solution that includes that additional swap. If the performance improvement of a swap is not sufficiently large to offset the penalty, then the optimization can move toward a solution that does not include that swap. An example method for measuring performance improvement can include a next token prediction measurement, which may be aggregated over an entire training example. Other performance measures may be used.

Other optimizations may be applied. For instance, combinatorial search techniques may be used to explore a search space of combinations of profiles for a given sequence. Evolutionary algorithms may be used.

Human labeled training examples may be used. For example, human annotators can interact with a labeling system to cause the labeling system to store domain or profile labels in association with portions of a data corpus. Training examples may be composed from the labeled portions of the training corpus.

Cross-profile training step(s) can be used to update each profile based on losses. The loss can be computed over all masked tokens or only the swap elements (e.g., swap profile element, profile identifier element, etc.).

In some implementations, cross-profile training step(s) can be applied without separately training the profiles individually. For instance, during cross-profile training, profiles can jointly learn both substantive skills and swap behaviors.

Model training system 400 can train machine-learned model 110 in an online manner. For example, model training system 400 can receive feedback on a model performance and execute a classifier to generate a classification output that indicates whether the feedback is domain specific (e.g., a computation is performed incorrectly, or an tool call fails to use a latest syntax for a new API release) or relates to swapping behavior (e.g., a response failed to engage a specialized tool for a particular task domain). Domain specific feedback can be used to initiate one or more profile-local training steps for refining or further training a specific profile associated with the domain. Cross-domain feedback can be used to initiate one or more cross-profile training steps for refining or further training one or multiple profiles to improve swap element prediction. The cross-domain feedback can be used to select training examples specific to a failure mode identified or a type of performance praised to reduce or reinforce behavior as needed.

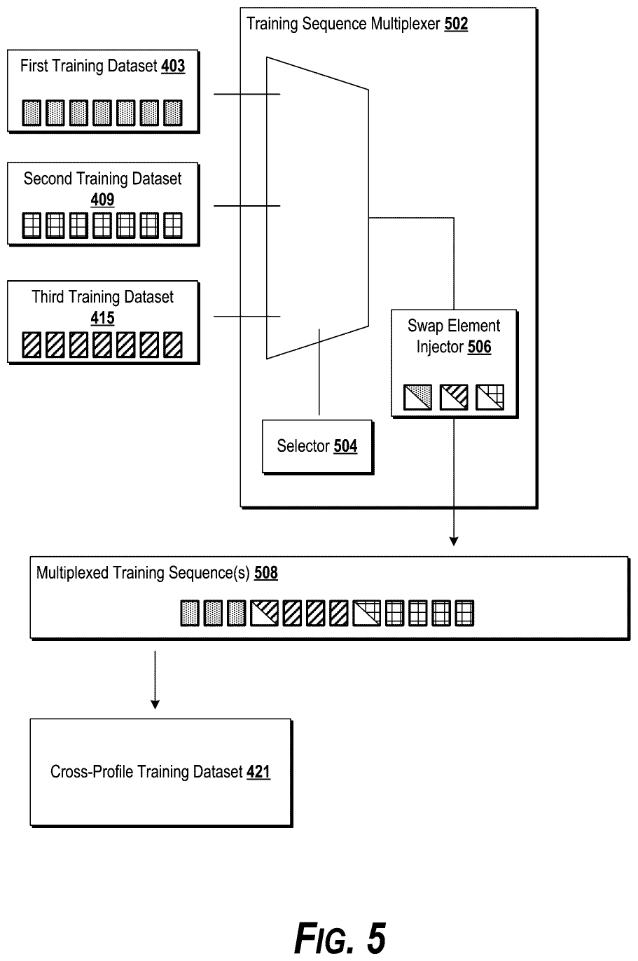

FIG. 5 is a block diagram of a system for generating training examples for a cross-domain training dataset for training one or more parameter profiles according to example aspects of the present disclosure.

A training sequence multiplexer 502 can access training sequences from each of a plurality of different datasets. A selector 504 can execute a selection algorithm (e.g., random selection) to select data from one or more of the sources. A swap element injector 506 can insert swap elements (e.g., swap profile element, profile identifier element, etc.) to indicate a transition between selected segments. The identity of the source dataset can be used to control the type of swap element injected. For instance, a profile identifier element prepended to a segment of a training example can correspond to a profile associated with a training dataset from which the segment was sourced.

In this manner, for instance, training sequence multiplexer 502 can generate, in an unsupervised fashion, multiplexed training sequences 508 that contain data from multiple different domains and swap elements interposed therebetween for populating cross-profile training dataset 421.

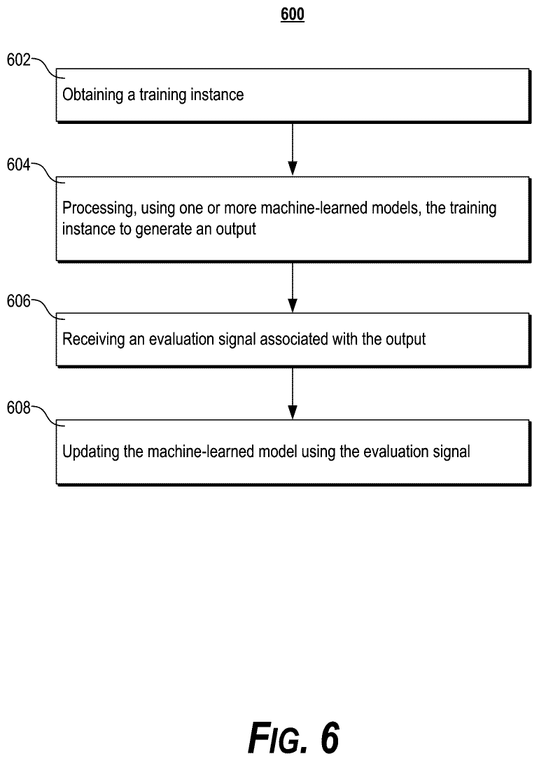

FIG. 6 depicts a flowchart of a method 600 for training one or more machine-learned models according to aspects of the present disclosure. For instance, an example machine-learned model can include a machine-learned model 110.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models. The output can be a final output or an intermediate output (e.g., a logit value associated with a given final output candidate).

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types. In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

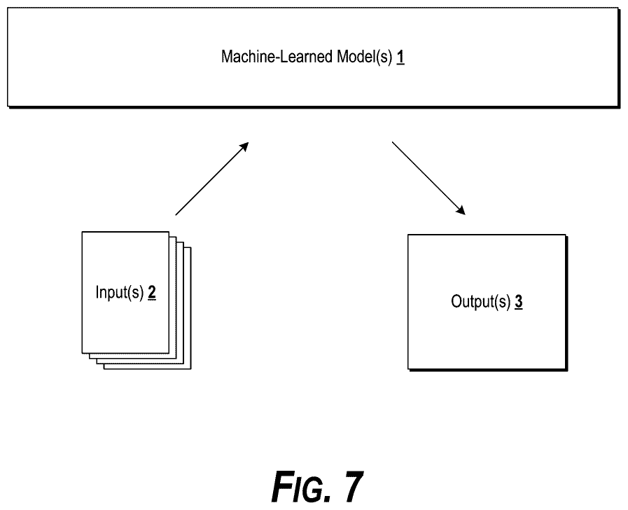

FIG. 7 is a block diagram of an example processing flow for using machine-learned model(s) 1 to process input(s) 2 to generate output(s) 3.

Machine-learned model(s) 1 can be or include any one of or any part of machine-learned models referenced with respect to the preceding figures (e.g., model 110 or any other model implemented using machine-learned model system 104). For example, any one or multiple of model 110 or any other model implemented using machine-learned model system 104 can be a machine-learned model 1. Features and variations described herein with respect to machine-learned model 1 are to be understood as describing features and variations of any of the machine-learned models described herein. Where this description references machine-learned model 1 it is to be understood that implementations of each of the other models described herein are implicitly referenced and represented thereby.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

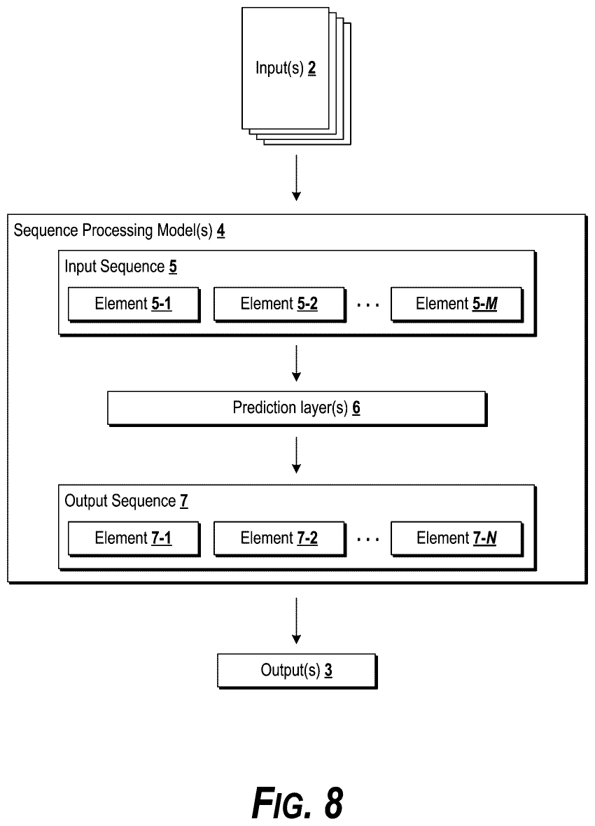

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

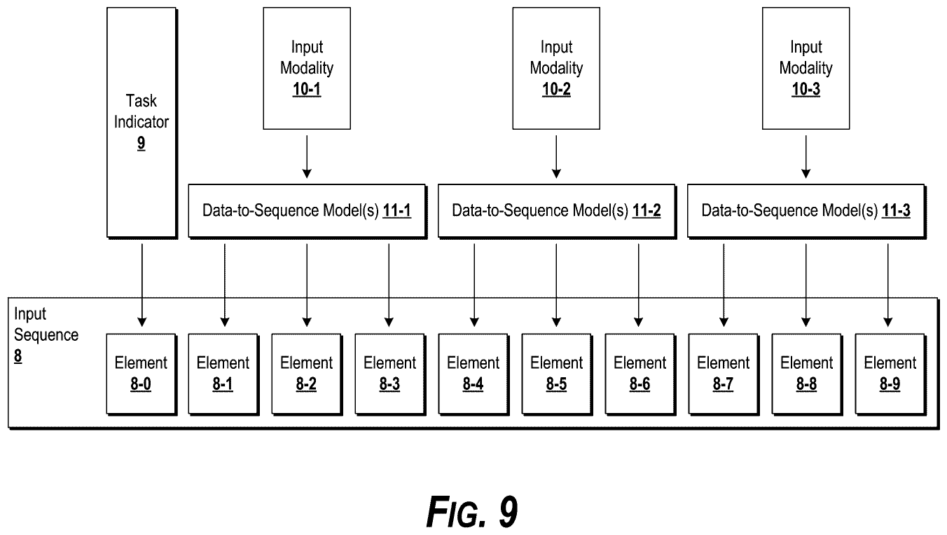

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

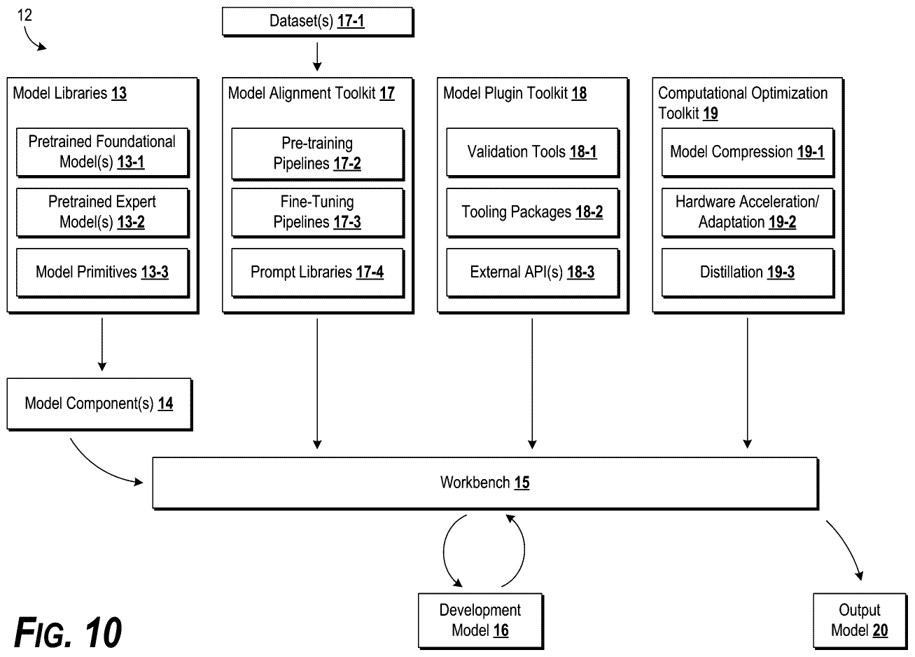

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

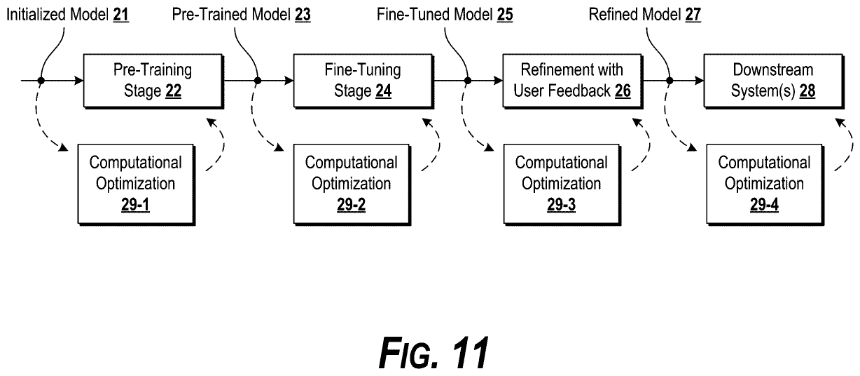

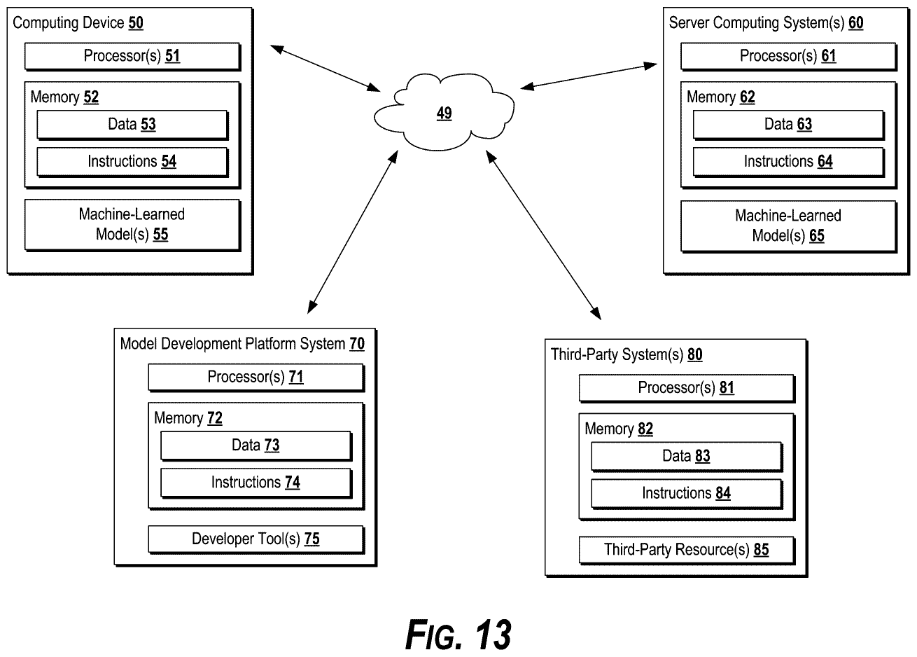

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

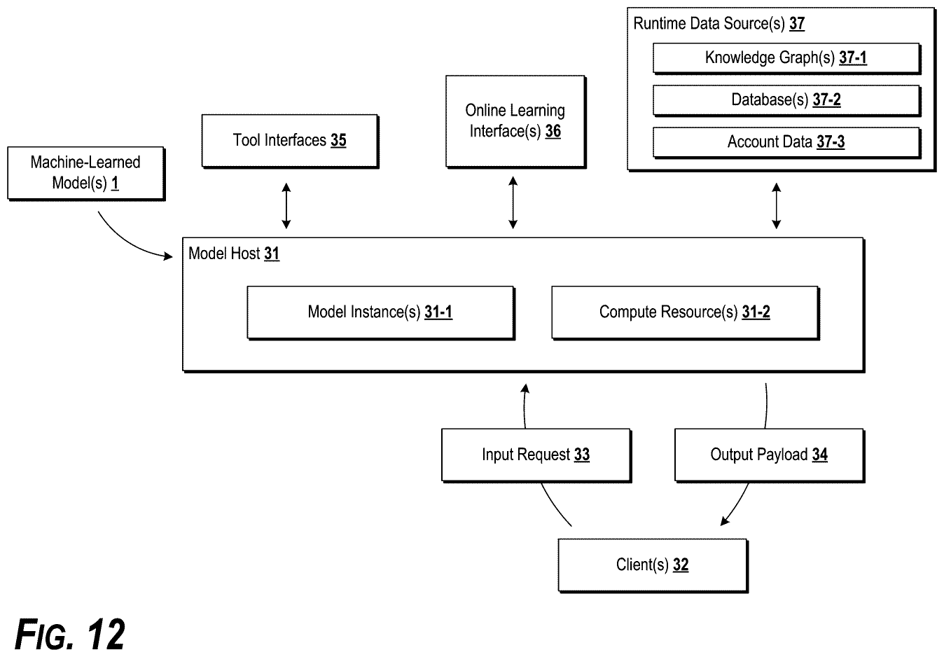

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

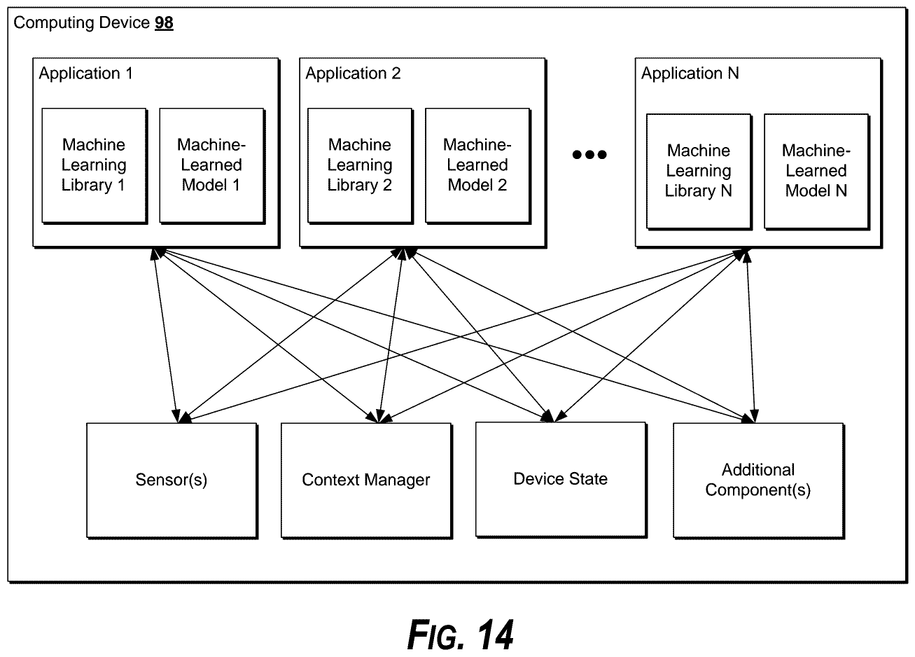

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

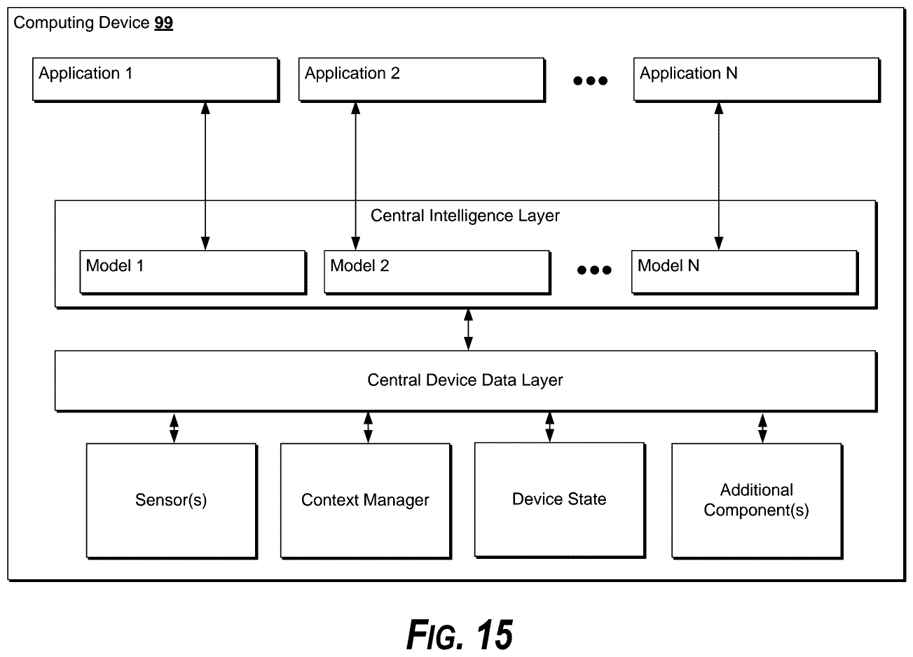

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

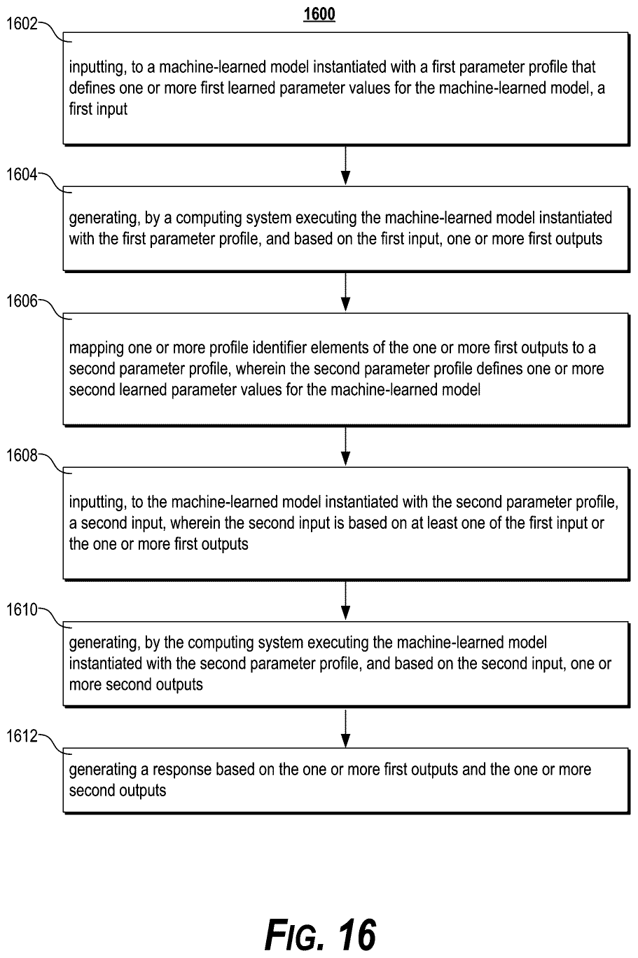

FIG. 16 depicts a flowchart of a method 1600 for implementing one or more machine-learned models according to aspects of the present disclosure. For instance, an example machine-learned model can include a machine-learned model 110.

One or more portion(s) of example method 1600 can be implemented by a computing system that includes one or more computing devices such as, for example, computing systems described with reference to the other figures. Each respective portion of example method 1600 can be performed by any (or any combination) of one or more computing devices. Moreover, one or more portion(s) of example method 1600 can be implemented on the hardware components of the device(s) described herein, for example, to train one or more systems or models. FIG. 16 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 16 is described with reference to elements/terms described with respect to other systems and figures for exemplary illustrated purposes and is not meant to be limiting. One or more portions of example method 1600 can be performed additionally, or alternatively, by other systems.

At 1602, example method 1600 includes inputting, to a machine-learned model (e.g., model 110, model 1, model 4, etc.) instantiated with a first parameter profile (e.g., profile 112-1) that defines one or more first learned parameter values for the machine-learned model, a first input (e.g., model input(s) 108). The first input can be or include a sequence. The first input can be based on a query (e.g., query 102). In an example, instantiating a machine-learned model can include loading the model parameters into cache of a processor, HBM associated with a hardware accelerator, VRAM associated with a GPU, RAM associated with a CPU, etc. The machine-learned model can be a sequence processing model. The one or more first learned parameter values for the machine-learned model can include values for parameters of a base portion of the model itself or values of parameters of adapter layers or other components added to the model (e.g., added via the first parameter profile).

At 1604, example method 1600 includes generating, by a computing system (e.g., machine-learned model system 104, model host 31, etc.) executing the machine-learned model instantiated with the first parameter profile, and based on the first input, one or more first outputs (e.g., output element(s) 114).

At 1606, example method 1600 includes mapping (e.g., using a profile manager 120) one or more profile identifier elements of the one or more first outputs to a second parameter profile (e.g., parameter profile 112-2), wherein the second parameter profile defines one or more second learned parameter values for the machine-learned model. The one or more second learned parameter values for the machine-learned model can include values for parameters of a base portion of the model itself or values of parameters of adapter layers or other components added to the model (e.g., added via the loading of the second parameter profile).

At 1608, example method 1600 includes inputting, to the machine-learned model instantiated with the second parameter profile, a second input (e.g., model input(s) 124), wherein the second input is based on at least one of the first input or the one or more first output elements. In some implementations, the second input is based on the query.

At 1610, example method 1600 includes generating, by the computing system executing the machine-learned model instantiated with the second parameter profile, and based on the second input, one or more second outputs (e.g., output value(s) 126).

At 1612, example method 1600 includes generating a response (e.g., output(s) 128) based on the one or more first outputs and the one or more second outputs. The response can be a response to the query. For example, a response can contain content based on elements output by machine-learned model 110. A response can include content generated by machine-learned model 110. A response can include a portion generated by the model instantiated according to the first profile and a portion generated by the model instantiated according to the second profile.

In some implementations, example method 1600 includes loading, into a memory of the computing system, a first plurality of values respectively for a plurality of learned parameters of the machine-learned model, the first plurality of values defined according to the first parameter profile. For example, a model host 31 (e.g., executing machine-learned model 110) can load parameter values associated with a model 110 into memory device(s) of compute resource(s) 31-2 (e.g., first memory device(s) 202-1, second memory device(s) 202-2, third memory device(s) 202-3, etc.).

In some implementations, example method 1600 includes generating the one or more first outputs using the first plurality of values. For example, machine-learned model 110 can execute an inference pass by performing operations in which internal activations of the model are transformed based on the first plurality of values. For example, a layer output can be computed by processing a layer input using one or more of the first plurality of values.

In some implementations, example method 1600 includes loading, into the memory, a second plurality of values respectively for the plurality of learned parameters, the second plurality of values defined according to the second parameter profile. For example, a second plurality of values may not initially be in a memory location. The second plurality of values can be loaded into the memory location. For example, the second plurality of values can be loaded into the memory location responsive to the mapping of the profile identifier element to the second parameter profile. The second plurality of values can be loaded into the memory location proactively, such as based on a predictive caching scheme or other technique that caches parameter profiles based on an expectation of use.

In some implementations, example method 1600 includes generating the one or more second output elements using the second plurality of values. For example, machine-learned model 110 can execute an inference pass by performing operations in which internal activations of the model are transformed based on the second plurality of values. For example, a layer output can be computed by processing a layer input using one or more of the second plurality of values.

In some implementations of example method 1600, the second parameter profile defines delta values, and wherein the second plurality of values are obtained by combining the delta values with corresponding baseline values for the plurality of learned parameters. For example, example method 1600 can include computing an updated set of parameter values and instantiating the model using the updated set of parameter values. Example method 1600 can include computing a first activation using a baseline set of values and computing a second activation using the second plurality of values and combining the activations.

In some implementations of example method 1600, the second parameter profile defines replacement values, and wherein the second plurality of values are obtained by replacing the baseline values with the corresponding replacement values.

In some implementations of example method 1600, the first plurality of values are the baseline values. For instance, the first parameter profile can be a null profile that does not modify a baseline set of values. For example, one or more profiles (e.g., second parameter profile 112-2) can adjust or adapt the baseline set of values using one or more learned parameters.

In some implementations of example method 1600, the loading, into the memory, of the second plurality of values is performed responsive to the mapping of the one or more profile identifier elements to the second parameter profile.

In some implementations of example method 1600, the second input comprises the first input. For example, the machine-learned model 110 instantiated with the second parameter profile can perform generation over a context window inclusive of at least some of the same context as processed by the machine-learned model 110 instantiated with the first parameter profile. In this manner, for instance, the model can perform generation with continuity over the context and generate different respective domain-specific portions with different respective profiles. For instance, the second input can include an initial prompt or instruction.

In some implementations of example method 1600, the second input comprises the one or more first outputs. For instance, the second input can include a response from the model to an initial prompt or instruction.

In some implementations, example method 1600 includes generating one or more first-profile activations based on the first input using the first parameter profile. For example, an activation can be the intermediate or output value generated, using a portion of a model, based on the input. The portion of the model may use one or more values defined by the first parameter profile.

In some implementations, example method 1600 includes generating the one or more first outputs based on the first-profile activations based on the first input. For instance, an output from a model can be generated based on a value of an activation value generated in an intermediate step internal to the model.

In some implementations, example method 1600 includes generating one or more second-profile activations based on the first input using the second parameter profile. For example, activations can be profile-specific. For instance, activations generated based on an input using one profile may be different from activations generated by the same model component configured according to a different profile (e.g., using different parameters). As such, swapping profiles and continuing to generate a response (e.g., output element(s) 126) based on a previously generated portion (e.g., output element(s) 114) can render previously-generated activations incompatible with a current profile. Activations (e.g., attention values) may be recomputed for the previously generated or processed portions (e.g., the first input sequence) using the current profile (e.g., the second parameter profile). Activations from the original profile may be stored in memory (e.g., RAM, VRAM, etc.) so that upon switching back to the original profile, the activations may be reused. For instance, only a portion of the response not generated using the original profile may then need to be recomputed using the original profile. In some implementations of example method 1600, the one or more first-profile activations based on the first input comprises attention values computed between elements in the first input using the one or more first learned parameter values.

In some implementations, example method 1600 includes generating the one or more second outputs based on the second-profile activations based on the first input. For instance, an output from a model can be generated based on a value of an activation value recomputed for an intermediate step internal to the model. In some implementations of example method 1600, the one or more second-profile activations based on the first input comprises attention values computed between the elements in the first input using the one or more second learned parameter values.

In some implementations, example method 1600 includes caching the one or more first-profile activations based on the first input. For example, to decrease a latency of swapping between profiles attributable to the recomputation of activations, multiple profiles may be used to generate activations (e.g., attention values) in parallel, even if only one profile is used for sampling the output element(s). In this manner, for instance, activations compatible with a selected profile may be retrieved from memory upon selection of the profile rather than recomputed after selection of the profile.

In some implementations, example method 1600 includes mapping, to the first parameter profile, one or more second profile identifier elements generated by the machine-learned model based on a third input that comprises or is based on the first input. In some implementations of example method 1600, the third input is or includes the second input. In some implementations of example method 1600, the one or more second outputs comprise the one or more second profile identifier elements. For example, at some state of the generation, after generating the second outputs, the system can detect and execute a swap back to the first parameter profile. For instance, the second outputs or subsequent output element(s) can contain one or more second profile identifier elements. Profile manager 120 can execute over the one or more second profile identifier elements to identify a swap back to the first parameter profile.

In some implementations, example method 1600 includes generating one or more first-profile activations based on the third input using the one or more first learned parameter values. In some implementations of example method 1600, generating the one or more first-profile activations based on the third input comprises, for a portion of the third input corresponding to the first input, retrieving the cached one or more first-profile activations based on the first input.

In some implementations, example method 1600 includes generating, by the computing system executing the machine-learned model instantiated with the first parameter profile, and based on the one or more first-profile activations based on the third input, one or more third outputs.

In some implementations of example method 1600, generating the one or more first outputs comprises: generating a swap profile element that signals a profile swap; and generating the one or more profile identifier elements. For example, a swap profile element can be a general swap signal that indicates a swap (e.g., but not a target profile to which to swap). A swap profile element can be a designated token in an output vocabulary of a model. In some implementations of example method 1600, the swap profile element is a token sampled from an output vocabulary of tokens of the machine-learned model based on a prediction value associated with the swap profile element, the prediction value conditioned on one or more preceding tokens in a context window of the machine-learned model. The one or more profile identifier elements can include a designated token for a specific profile (e.g., <token id=“123” associated with image editing). The one or more profile identifier elements can include natural language tokens that are composed to correspond to a name or other identifier of a profile (e.g., a sequence of tokens “Image” and “Editor,” combined, associated with image editing).

In some implementations, example method 1600 includes training the one or more first parameter values using a first training dataset (e.g., training dataset 403). In some implementations of example method 1600, training the one or more first parameter values (e.g., in profile-local training step(s) 402) comprises, for a respective batch of one or more first training examples in the first training dataset, inputting, to the machine-learned model, at least a portion of the respective batch of one or more first training examples (e.g., training input(s) 404); generating, by the machine-learned model instantiated with the first parameter profile, one or more first outputs (e.g., training output(s) 406); computing a first loss based on the one or more first outputs; and generating, based on the first loss, a first training update for the first parameter profile.

In some implementations, example method 1600 includes training the one or more second parameter values using a second training dataset (e.g., training dataset 409). In some implementations of example method 1600, training the one or more second parameter values (e.g., in profile-local training step(s) 408) comprises, for a respective batch of one or more second training examples in the second training dataset: inputting, to the machine-learned model, at least a portion of the respective batch of one or more second training examples (e.g., training input(s) 410); generating, by the machine-learned model instantiated with the second parameter profile, one or more second outputs (e.g., training output(s) 412); computing a second loss based on the one or more second outputs; and generating, based on the second loss, a second training update for the second parameter profile.

In some implementations, example method 1600 includes storing the one or more first parameter values in association with a first identifier. For example, the first parameter profile can be stored in a data structure (e.g., a database or other data store) in association with (e.g., queryable by) the first identifier. A first identifier can correspond to a first profile identifier element. The one or more first profile identifier elements can indicate the first identifier, and the first parameter profile can be retrieved using the first identifier. A first identifier can be a profile name or other identifier.

In some implementations, example method 1600 includes storing the one or more second parameter values in association with a second identifier indicated by the one or more profile identifier elements. For example, the second parameter profile can be stored in a data structure (e.g., a database or other data store) in association with (e.g., queryable by) the second identifier. A second identifier can correspond to a second profile identifier element. The one or more second profile identifier elements can indicate the second identifier, and the second parameter profile can be retrieved using the second identifier. A second identifier can be a profile name or other identifier.

In some implementations, example method 1600 includes training the one or more first parameter values using a training example that comprises the one or more profile identifier elements. For instance, machine-learned model 110 can be trained over a cross-profile training dataset (e.g., dataset 421) that contains examples of desired profile-switching behavior. In some implementations of example method 1600, training the one or more first parameter values using the training example that comprises the one or more profile identifier elements (e.g., in cross-profile training step(s) 420) comprises providing a masked training input to the machine-learned sequence processing model instantiated with the first parameter profile, wherein the masked training input comprises a portion of the training example with the one or more profile identifier elements masked. In some implementations of example method 1600, training the one or more first parameter values using the training example that comprises the one or more profile identifier elements comprises generating, by the machine-learned sequence processing model instantiated with the first parameter profile, one or more training outputs associated with one or more training output tokens. In some implementations of example method 1600, training the one or more first parameter values using the training example that comprises the one or more profile identifier elements comprises computing a training loss that indicates an alignment between the one or more training outputs and the masked one or more profile identifier elements. In some implementations of example method 1600, training the one or more first parameter values using the training example that comprises the one or more profile identifier elements comprises training the first parameter profile based on the training loss.

In some implementations, example method 1600 includes sampling tokens from the training example to mask based on a distribution over the tokens in the training example, wherein one or more distribution values associated with the one or more profile identifier elements are selected to indicate a higher likelihood of being sampled, on a normalized basis, than a baseline value associated with a proportion of training examples corresponding to the one or more profile identifier elements. For example, as compared to ordinary vocabulary tokens, swap profile elements and profile identifier elements may appear less frequently. However, they may be impactful for training profile swapping behavior. It may be desired to increase a likelihood that a masked-language-modeling technique masks the swap profile elements and profile identifier elements to give the model more opportunities to learn profile swapping behavior.

In some implementations, example method 1600 includes inputting training example source material associated with a candidate training example to a machine-learned example generation model. In some implementations, example method 1600 includes generating, by the machine-learned example generation model and based on the training example source material, an output indicating a proposed profile swap from the first parameter profile to the second parameter profile. For example, a machine-learned model (e.g., machine-learned model 110 or another machine-learned model) can process a portion of a training corpus in view of (e.g., in a combined input with) a list of available profiles, and the model can label portions of the training example with corresponding profiles. In this manner, for instance, a model can predict a likely best profile for each segment of a training example. The segments can be pre-existing or can also be predicted. For instance, a segmentation technique can include predicting segments or segment boundaries. A machine-learned model can predict the segments (e.g., by outputting a list of segments) or segment boundaries (e.g., by outputting indices associated with positions of a boundary of a segment). In an example, a model can predict where swap profile elements are to be inserted, as well as a profile identifier indicating which profile should be used for subsequent portions of the example.

In some implementations, example method 1600 includes computing a performance measure of the machine-learned model using the proposed profile swap over the training example source material. In some implementations, example method 1600 includes updating, based on the performance measure, the training example to include the proposed profile swap. For instance, the segments or profiles can be selected to optimize a performance over cross-domain training examples, and injected swap points can be added or pruned, and profile identifiers can be adjusted, based on whether the changes affect a performance of the model. The optimization objective can include a term or aspect that discourages profile swapping unless sufficient benefit is realized. For example, profile swapping can be associated with a computational cost overhead (e.g., moving parameters in memory, recomputing activations, etc.). Marginal performance improvements of low magnitude may not be sufficient to offset this swap cost. As such, the optimization objective can include a term that penalizes a number of swaps per response. If the performance improvement of a swap is sufficiently large to offset the penalty, then the optimization can move toward a solution that includes that additional swap. If the performance improvement of a swap is not sufficiently large to offset the penalty, then the optimization can move toward a solution that does not include that swap. An example method for measuring performance improvement can include a next token prediction measurement, which may be aggregated over an entire training example. Other performance measures may be used.

In some implementations, example method 1600 includes storing the candidate training example in a training dataset.

Although various illustrative examples of techniques described herein are explained with reference to machine-learned sequence processing models, it is to be understood that the profile-swapping techniques presented herein can be used for a variety of different models that may perform inference over one or more iterations. For example, a diffusion-based model may be used.

For instance, in an example implementation of example method 1600, a diffusion model can be instantiated with a first parameter profile to begin an image generation task (e.g., beginning to refine a noisy input, such as by generating coarse features). The first input can be a first state of the generated image at a first iteration. The one or more first outputs can be updated pixel values or latent states associated with the image. The one or more first outputs can include multi-channel outputs.

A profile identifier element can be a value generated by the model. The value can be in a color channel of the image in an unused band of color values (e.g., on the extremes of perceptible color differences, such as between 0 and 10 on a 0 to 255 value scale). The value can be output in a separate channel from image pixel values or in a separate output stream altogether (e.g., a separate buffer or queue for profile identifier elements).

Based on detecting a profile identifier element, a control system can load updated parameter values for the diffusion model based on a second parameter profile.

In this manner, then, example method 1600 can include inputting, to the machine-learned model instantiated with the second parameter profile, a second input, which may be a current image input for a current iteration of the iterative refinement or generation task. As the iterations may be conditioned directly or indirectly on the updates/refinements made in prior iterations, the second input can be based on at least one of the first input or the one or more first outputs. The model, using the second parameter profile, can generate an output for the current iteration. After completing the iterations, the model can output a response based on the iterations completed.

In this manner, for instance, an iterative processing model can adapt during the course of iteration. For example, as coarse image features take shape (e.g., visible features or latent features), the model can predict a profile that would be likely to improve performance on the subject matter or style of the image. The prediction can be based on the current state of the image features. The model can swap its parameters to continue the denoising or refinement process with a skill set adapted to the context of the image.

Masks can be used to allow different profiles to operate over specific portions of an image. For example, a baseline model can begin to generate the image. After recognizing a type of object in a scene, a profile associated with that type of object can be loaded for refinement of that object. A mask can be generated to segment the image around the object so that the object-specific profile can edit the image around the object without disturbing the remainder of the scene. This region-specific approach can continue until no specific objects trigger further profile swaps. Optionally a final pass can include using a generalist profile to smooth or integrate the outputs.

In an example, the profile identifiers can be output in parallel. Multiple profiles can be loaded in parallel. For instance, a profile identifier can be predicted for each pixel in an image or for one or more regions of the image to form a map of profile identifiers. Those pixels or regions can subsequently be edited or denoised by the model using a corresponding set of model parameters associated with the predicted identifiers.

For instance, at each iteration, the model could predict a set of parameter profiles used to process the next iteration. The pixels or regions associated with individual profile predictions can correspond to slices of a tensor of learned parameters. Based on the predicted map of profile identifiers, a model host system can load into memory the parameters associated with the slices of the tensors. For example, the model host system can omit loading into memory parameters not associated with the slices of the tensors.

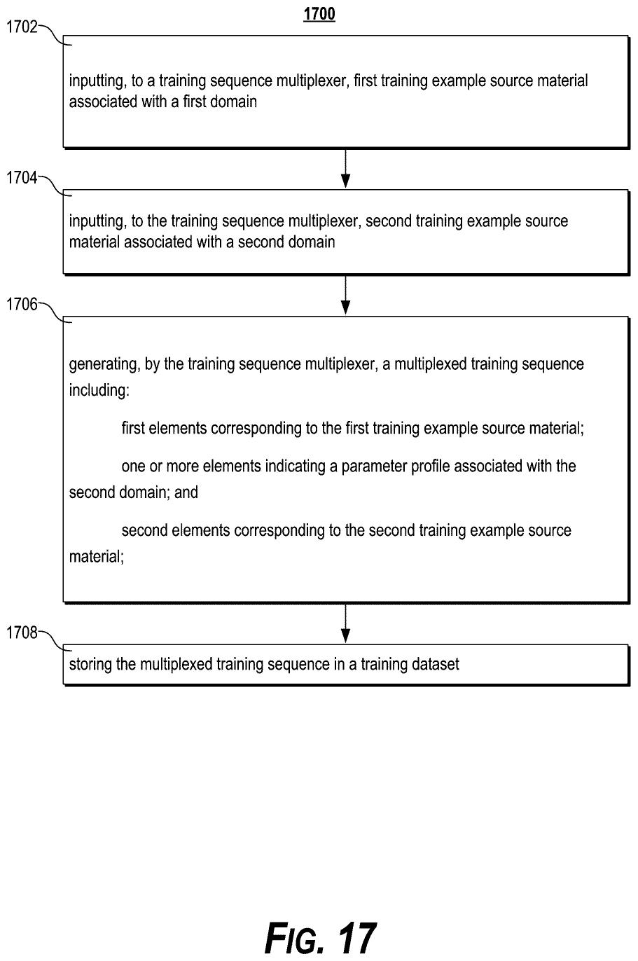

FIG. 17 depicts a flowchart of a method 1700 for generating training data for training one or more machine-learned models according to aspects of the present disclosure. For instance, an example machine-learned model can include a machine-learned model 110.

One or more portion(s) of example method 1700 can be implemented by a computing system that includes one or more computing devices such as, for example, computing systems described with reference to the other figures. Each respective portion of example method 1700 can be performed by any (or any combination) of one or more computing devices. Moreover, one or more portion(s) of example method 1700 can be implemented on the hardware components of the device(s) described herein, for example, to train one or more systems or models. FIG. 17 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 17 is described with reference to elements/terms described with respect to other systems and figures for exemplary illustrated purposes and is not meant to be limiting. One or more portions of example method 1700 can be performed additionally, or alternatively, by other systems.

At 1702, example method 1700 includes inputting, to a training sequence multiplexer, first training example source material associated with a first domain. For example, a training sequence multiplexer 502 can access training sequences from each of a plurality of different datasets. A selector 504 can execute a selection algorithm (e.g., random selection) to select data from one or more of the sources. A computing system can input data from a source to the training sequence multiplexer.

At 1704, example method 1700 includes inputting, to the training sequence multiplexer, second training example source material associated with a second domain. A computing system can input data from the same source or a different source to the training sequence multiplexer.

At 1706, example method 1700 includes generating, by the training sequence multiplexer, a multiplexed training sequence (e.g., multiplexed training sequence 508). The multiplexed training sequence can include first elements corresponding to the first training example source material (e.g., data from a first source, such as a first training dataset). The multiplexed training sequence can include one or more elements indicating a parameter profile associated with the second domain. For instance, a swap element injector 506 can insert swap elements (e.g., swap profile element, profile identifier element, etc.) to indicate a transition between selected segments. The identity of the source dataset can be used to control the type of swap element injected. For instance, a profile identifier element prepended to a segment of a training example can correspond to a profile associated with a training dataset from which the segment was sourced. The multiplexed training sequence can include second elements corresponding to the second training example source material (e.g., data from a second source, such as a second training dataset).

At 1708, example method 1700 includes storing the multiplexed training sequence in a training dataset. For example, multiplexed training sequences 508 can be stored in cross-profile training dataset 421. Cross-profile training dataset 421 can be used to train a machine-learned model to swap profiles during execution according to example implementations of the present disclosure (e.g., according to aspects of example method 1600).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
inputting, to a machine-learned model instantiated with a first parameter profile that defines one or more first learned parameter values for the machine-learned model, a first input;
generating, by a computing system executing the machine-learned model instantiated with the first parameter profile, and based on the first input, one or more first outputs;
mapping one or more profile identifier elements of the one or more first outputs to a second parameter profile, wherein the second parameter profile defines one or more second learned parameter values for the machine-learned model;
inputting, to the machine-learned model instantiated with the second parameter profile, a second input, wherein the second input is based on at least one of the first input or the one or more first outputs;
generating, by the computing system executing the machine-learned model instantiated with the second parameter profile, and based on the second input, one or more second outputs; and
generating a response based on the one or more first outputs and the one or more second outputs.

2. The computer-implemented method of claim 1, comprising:
loading, into a memory of the computing system, a first plurality of values respectively for a plurality of learned parameters of the machine-learned model, the first plurality of values defined according to the first parameter profile;
generating the one or more first outputs using the first plurality of values;
loading, into the memory, a second plurality of values respectively for the plurality of learned parameters, the second plurality of values defined according to the second parameter profile; and
generating the one or more second outputs using the second plurality of values.

3. The computer-implemented method of claim 2, wherein the second parameter profile defines delta values, and wherein the second plurality of values are obtained by combining the delta values with corresponding baseline values for the plurality of learned parameters.

4. The computer-implemented method of claim 3, wherein the first plurality of values are the baseline values.

5. The computer-implemented method of claim 2, wherein the loading, into the memory, of the second plurality of values is performed responsive to the mapping of the one or more profile identifier elements to the second parameter profile.

6. The computer-implemented method of claim 1, wherein the second input comprises the first input.

7. The computer-implemented method of claim 6, wherein the second input comprises the one or more first outputs.

8. The computer-implemented method of claim 6, comprising:
generating one or more first-profile activations based on the first input using the first parameter profile;
generating the one or more first outputs based on the first-profile activations based on the first input;
generating one or more second-profile activations based on the first input using the second parameter profile; and
generating the one or more second outputs based on the second-profile activations based on the first input.

9. The computer-implemented method of claim 8, wherein:
the one or more first-profile activations based on the first input comprises attention values computed between elements of the first input using the one or more first learned parameter values;
the one or more second-profile activations based on the first input comprises attention values computed between the elements in the first input using the one or more second learned parameter values.

10. The computer-implemented method of claim 8, comprising:
caching the one or more first-profile activations based on the first input;
mapping, to the first parameter profile, one or more second profile identifier elements generated by the machine-learned model based on a third input that comprises the first input;
generating one or more first-profile activations based on the third input using the one or more first learned parameter values, wherein generating the one or more first-profile activations based on the third input comprises, for a portion of the third input corresponding to the first input, retrieving the cached one or more first-profile activations based on the first input;
generating, by the computing system executing the machine-learned model instantiated with the first parameter profile, and based on the one or more first-profile activations based on the third input, one or more third outputs.

11. The computer-implemented method of claim 10, wherein:
the third input is the second input; and
the one or more second outputs comprise the one or more second profile identifier elements.

12. The computer-implemented method of claim 1, wherein generating the one or more first outputs comprises:
generating a swap profile element that signals a profile swap; and
generating the one or more profile identifier elements.

13. The computer-implemented method of claim 12, wherein the swap profile element is a token sampled from an output vocabulary of tokens of the machine-learned model based on a prediction value associated with the swap profile element, the prediction value conditioned on one or more preceding tokens in a context window of the machine-learned model.

14. The computer-implemented method of claim 1, comprising:
training the one or more first parameter values using a first training dataset, wherein training the one or more first parameter values comprises:
for a respective batch of one or more first training examples in the first training dataset:
inputting, to the machine-learned model, at least a portion of the respective batch of one or more first training examples;
generating, by the machine-learned model instantiated with the first parameter profile, one or more respective first outputs;
computing a first respective loss based on the one or more respective first outputs; and
generating, based on the first respective loss, a first respective training update for the first parameter profile;
training the one or more second parameter values using a second training dataset, wherein training the one or more second parameter values comprises:
for a respective batch of one or more second training examples in the second training dataset:
inputting, to the machine-learned model, at least a portion of the respective batch of one or more second training examples;
generating, by the machine-learned model instantiated with the second parameter profile, one or more respective second outputs;
computing a second respective loss based on the one or more respective second outputs; and
generating, based on the second respective loss, a second respective training update for the second parameter profile.

15. The computer-implemented method of claim 14, comprising:
storing the one or more first parameter values in association with a first identifier; and
storing the one or more second parameter values in association with a second identifier indicated by the one or more profile identifier elements.

16. The computer-implemented method of claim 1, comprising:
training the one or more first parameter values using a training example that comprises the one or more profile identifier elements;
wherein training the one or more first parameter values using the training example that comprises the one or more profile identifier elements comprises:
providing a masked training input to the machine-learned model instantiated with the first parameter profile, wherein the masked training input comprises a portion of the training example with the one or more profile identifier elements masked;
generating, by the machine-learned model instantiated with the first parameter profile, one or more training outputs associated with one or more training output tokens;
computing a training loss that indicates an alignment between the one or more training outputs and the masked one or more profile identifier elements; and
training the first parameter profile based on the training loss.

17. The computer-implemented method of claim 16, comprising:
sampling tokens from the training example to mask based on a distribution over the tokens in the training example, wherein one or more distribution values associated with the one or more profile identifier elements are selected to indicate a higher likelihood of being sampled, on a normalized basis, than a baseline value associated with a proportion of training example corresponding to the one or more profile identifier elements.

18. The computer-implemented method of claim 16, comprising:
training the one or more first parameter values using a first training dataset;
wherein training the one or more first parameter values comprises:
for a respective batch of one or more first training examples in the first training dataset:
inputting, to the machine-learned model, at least a portion of the respective batch of one or more first training examples;
generating, by the machine-learned model instantiated with the first parameter profile, one or more first respective outputs;
computing a first respective loss based on the one or more first respective outputs; and
generating, based on the first respective loss, a first respective training update for the first parameter profile;
training the one or more second parameter values using a second training dataset, wherein training the one or more second parameter values comprises:
for a respective batch of one or more second training examples in the second training dataset:
inputting, to the machine-learned model, at least a portion of the respective batch of one or more second training examples;
generating, by the machine-learned model instantiated with the second parameter profile, one or more second respective outputs;
computing a second respective loss based on the one or more second respective outputs; and
generating, based on the second loss, a second training update for the second parameter profile.

19. The computer-implemented method of claim 14, comprising:
inputting training example source material associated with a candidate training example to a machine-learned example generation model;
generating, by the machine-learned example generation model and based on the training example source material, an output indicating a proposed profile swap from the first parameter profile to the second parameter profile;
computing a performance measure of the machine-learned model using the proposed profile swap over the training example source material;
updating, based on the performance measure, the training example to include the proposed profile swap; and
storing the candidate training example in a training dataset.

20. A computer-implemented method of generating training data for training a machine-learned sequence processing model to swap parameter profiles, the method comprising:
inputting, to a training sequence multiplexer, first training example source material associated with a first domain;
inputting, to the training sequence multiplexer, second training example source material associated with a second domain;
generating, by the training sequence multiplexer, a multiplexed training sequence comprising:
first elements corresponding to the first training example source material;
one or more elements indicating a parameter profile associated with the second domain; and
second elements corresponding to the second training example source material; and
storing the multiplexed training sequence in a training dataset.
